(19) United States
(12) Patent Application Publication
(10) Pub. No.: US 2026/0228742 A1
(43) Pub. Date: Aug. 6, 2026

(54) System, Method, and Computer Program Product for Multi Account Access Based on a Single Credential

(71) Applicant: Visa International Service Association, San Francisco, CA (US)

(72) Inventors: Barbara Elizabeth Patterson, South San Francisco, CA (US); C. William Byrne, Portland, OR (US); Judy John, Hillsborough, CA (US)

(21) Appl. No.: 19/149,948

(22) PCT Filed: Jan. 24, 2024
(86) PCT No.: PCT/US2024/012788

§ 371 Date: Jul. 22, 2025

Related U.S. Application Data
(60) Provisional application No. 63/481,359, filed on Jan. 24, 2023.
(60) Provisional application No. 63/485,516, filed on Feb. 16, 2023.

(51) Int. Cl. G06Q 20/40

(52) U.S. Cl. CPC G06Q 20/405

(57) ABSTRACT

Systems, methods, and computer program products are provided for multi account access based on a single credential. An example system includes at least one processor configured to receive an authorization request message associated with a transaction that has a first account identifier. Whether the transaction and/or the first account identifier qualifies for dynamic processing is determined. At least one processing option available for the dynamic processing of the transaction is identified. A modified authorization request message is transmitted to an issuer system that indicates the processing option(s). An authorization response message is received from the issuer system that has an authorization indicator and an identifier for a funding source compatible with a selected processing option. A modified authorization response message is transmitted based on the authorization indicator and the identifier for the funding source to the acquirer system.

### CROSS REFERENCE TO RELATED APPLICATIONS

This application is the United States national phase of International Application No. PCT/US24/12788, filed on Jan. 24, 2024, and claims the benefit of U.S. Provisional Patent Application No. 63/481,359, filed on Jan. 24, 2023, and U.S. Provisional Patent Application No. 63/485,516, filed on Feb. 16, 2023, the disclosures of which are hereby incorporated by reference in their entireties.

### BACKGROUND

### 1. Technical Field

This disclosure relates generally to transaction message routing and, in some non-limiting embodiments or aspects, to systems, methods, and computer program products for multi account access based on a single credential.

### 2. Technical Considerations

Electronic payment processing systems may use an account identifier to initiate and/or settle a transaction. For example, a payment transaction may be initiated with a credit card number (e.g., primary account number (PAN)) at a merchant system, and the same credit card number may be used to settle that transaction at a later time. In such systems, each payment device (e.g., a credit card, a debit card, a prepaid card, etc.) may have a single account number (e.g., PAN) associated therewith.

However, such systems may require a user to physically select a different payment device (or remember to type in the account identifier of a different payment device) in order to use a different account for different types of transactions. As such, the user may be required to carry multiple different payment devices and/or memorize different account identifiers. Moreover, these electronic payment processing systems do not allow a user to substitute a different account and/or different account type (e.g. debit card account, credit card account, pre-paid card account, etc.) once the payment transaction is initiated with a certain payment device. Additionally, these payment processing systems do not allow a transaction to be settled with a different account and/or account type than the account associated with the payment device used to initiate a transaction. This poses difficulty in situations where a settlement process of the payment transaction is denied or hindered for unknown reasons. Furthermore, these electronic payment processing systems allow for only one funding source to be associated with a credential (e.g., account identifier).

### SUMMARY

Accordingly, provided are improved systems, methods, and computer program products for multi account access based on a single credential (e.g., that overcome some or all of the deficiencies identified above).

According to non-limiting embodiments or aspects, provided is a system for multi account access based on a single credential. An example system may include at least one processor configured to receive, from an acquirer system, an authorization request message associated with a transaction. The authorization request message may include a first account identifier. Whether at least one of the transaction, the first account identifier, or any combination thereof qualifies for dynamic processing is determined. At least one processing option available for the dynamic processing of the transaction is identified. A modified authorization request message is transmitted to an issuer system. The modified authorization request message may indicate the at least one processing option. An authorization response message may be received from the issuer system. The authorization response message may include an authorization indicator and an identifier for a funding source compatible with a selected processing option of the at least one processing option. A modified authorization response message based on the authorization indicator and the identifier for the funding source may be transmitted to the acquirer system.

In some non-limiting embodiments or aspects, the first account identifier may include a lead credential.

In some non-limiting embodiments or aspects, the lead credential may identify at least one of an accountholder, a default payment account, or any combination thereof.

In some non-limiting embodiments or aspects, dynamic processing may include deferred processing.

In some non-limiting embodiments or aspects, the identifier for the funding source may include a second account identifier.

In some non-limiting embodiments or aspects, the identifier for the funding source comprises at least one of a product identifier (PID), an account funding source (AFS), or any combination thereof.

In some non-limiting embodiments or aspects, the at least one processing option may include at least two processing options associated with a same funding source.

In some non-limiting embodiments or aspects, the at least one processing option may include at least two processing options each associated with a different funding source.

In some non-limiting embodiments or aspects, the at least one processor may be further configured to, before transmitting the modified authorization response message, process the transaction based on the identifier for the funding source and the selected processing option, and/or generate the modified authorization response message based on processing the transaction.

In some non-limiting embodiments or aspects, the issuer system may be configured to determine the selected processing option based on customized rules associated with an account holder associated with the first account identifier, determine the funding source compatible with the selected processing option, and/or generate the authorization response message comprising the authorization indicator and the identifier for the funding source compatible with the selected processing option.

In some non-limiting embodiments or aspects, the issuer system may be configured to receive at least one input associated with the customized rules from the account holder.

According to non-limiting embodiments or aspects, provided is a method for multi account access based on a single credential. An example computer-implemented method may include receiving, from an acquirer system, an authorization request message associated with a transaction. The authorization request message may include a first account identifier. Whether at least one of the transaction, the first account identifier, or any combination thereof qualifies for dynamic processing may be determined. At least one processing option available for the dynamic processing of the transaction may be identified. A modified authorization request message may be transmitted to an issuer system, the modified authorization request message indicating the at least one processing option. An authorization response message may be received from the issuer system. The authorization response message may include an authorization indicator and an identifier for a funding source compatible with a selected processing option of the at least one processing option. A modified authorization response message based on the authorization indicator and the identifier for the funding source may be transmitted to the acquirer system.

In some non-limiting embodiments or aspects, the first account identifier may include a lead credential. In some non-limiting embodiments or aspects, the lead credential may identify at least one of an accountholder, a default payment account, or any combination thereof.

In some non-limiting embodiments or aspects, dynamic processing may include deferred processing.

In some non-limiting embodiments or aspects, the identifier for the funding source may include a second account identifier.

In some non-limiting embodiments or aspects, the identifier for the funding source may include at least one of a product identifier (PID), an account funding source (AFS), or any combination thereof.

In some non-limiting embodiments or aspects, the at least one processing option may include at least one of the following: at least two processing options associated with a same funding source, at least two processing options each associated with a different funding source, or any combination thereof.

In some non-limiting embodiments or aspects, before transmitting the modified authorization response message, the transaction may be processed based on the identifier for the funding source and the selected processing option before transmitting the modified authorization response message, and/or the modified authorization response message may be generated based on processing the transaction.

In some non-limiting embodiments or aspects, the issuer system may receive at least one input associated with customized rules from an account holder associated with the first account identifier, determining the selected processing option based on the customized rules associated with the account holder, determine the funding source compatible with the selected processing option, and/or generate the authorization response message including the authorization indicator and the identifier for the funding source compatible with the selected processing option.

According to non-limiting embodiments or aspects, provided is a computer program product for multi account access based on a single credential. An example computer program product may include at least one non-transitory computer-readable medium including program instructions that, when executed by at least one processor, cause the at least one processor to receive, from an acquirer system, an authorization request message associated with a transaction. The authorization request message may include a first account identifier. Whether at least one of the transaction, the first account identifier, or any combination thereof qualifies for dynamic processing is determined. At least one processing option available for the dynamic processing of the transaction is identified. A modified authorization request message is transmitted to an issuer system. The modified authorization request message may indicate the at least one processing option. An authorization response message may be received from the issuer system. The authorization response message may include an authorization indicator and an identifier for a funding source compatible with a selected processing option of the at least one processing option. A modified authorization response message based on the authorization indicator and the identifier for the funding source may be transmitted to the acquirer system.

According to non-limiting embodiments or aspects, provided is a computer program product for multi account access based on a single credential. An example computer program product may include at least one non-transitory computer-readable medium including program instructions that, when executed by at least one processor, cause the at least one processor to perform any of the methods described herein.

Further non-limiting embodiments or aspects are set forth in the following numbered clauses:

Clause 1: A system, comprising: at least one processor configured to: receive, from an acquirer system, an authorization request message associated with a transaction, the authorization request message comprising a first account identifier; determine that at least one of the transaction, the first account identifier, or any combination thereof qualifies for dynamic processing; identify at least one processing option available for the dynamic processing of the transaction; transmit a modified authorization request message to an issuer system, the modified authorization request message indicating the at least one processing option; receive an authorization response message from the issuer system, the authorization response message comprising an authorization indicator and an identifier for a funding source compatible with a selected processing option of the at least one processing option; and transmit a modified authorization response message based on the authorization indicator and the identifier for the funding source to the acquirer system.

Clause 2: The system of clause 1, wherein the first account identifier comprises a lead credential.

Clause 3: The system of clause 1 or clause 2, wherein the lead credential identifies at least one of an accountholder, a default payment account, or any combination thereof.

Clause 4: The system of any of clauses 1-3, wherein dynamic processing comprises deferred processing.

Clause 5: The system of any of clauses 1-4, wherein the identifier for the funding source comprises a second account identifier.

Clause 6: The system of any of clauses 1-5, wherein the identifier for the funding source comprises at least one of a product identifier (PID), an account funding source (AFS), or any combination thereof.

Clause 7: The system of any of clauses 1-6, wherein the at least one processing option comprises at least two processing options associated with a same funding source.

Clause 8: The system of any of clauses 1-7, wherein the at least one processing option comprises at least two processing options each associated with a different funding source.

Clause 9: The system of any of clauses 1-8, wherein the at least one processor is further configured to, before transmitting the modified authorization response message: process the transaction based on the identifier for the funding source and the selected processing option; and generate the modified authorization response message based on processing the transaction.

Clause 10: The system of any of clauses 1-9, wherein the issuer system is configured to: determine the selected processing option based on customized rules associated with an account holder associated with the first account identifier; determine the funding source compatible with the selected processing option; and generate the authorization response message comprising the authorization indicator and the identifier for the funding source compatible with the selected processing option.

Clause 11: The system of any of clauses 1-10, wherein the issuer system is configured to receive at least one input associated with the customized rules from the account holder.

Clause 12: A computer-implemented method, comprising: receiving, with at least one processor from an acquirer system, an authorization request message associated with a transaction, the authorization request message comprising a first account identifier; determining, with at least one processor, that at least one of the transaction, the first account identifier, or any combination thereof qualifies for dynamic processing; identifying, with at least one processor, at least one processing option available for the dynamic processing of the transaction; transmitting, with at least one processor, a modified authorization request message to an issuer system, the modified authorization request message indicating the at least one processing option; receiving, with at least one processor, an authorization response message from the issuer system, the authorization response message comprising an authorization indicator and an identifier for a funding source compatible with a selected processing option of the at least one processing option; and transmitting, with at least one processor, a modified authorization response message based on the authorization indicator and the identifier for the funding source to the acquirer system.

Clause 13: The method of clause 12, wherein the first account identifier comprises a lead credential, and wherein the lead credential identifies at least one of an accountholder, a default payment account, or any combination thereof.

Clause 14: The method of clause 12 or clause 13, wherein dynamic processing comprises deferred processing.

Clause 15: The method of any of clauses 12-14, wherein the identifier for the funding source comprises a second account identifier.

Clause 16: The method of any of clauses 12-15, wherein the identifier for the funding source comprises at least one of a product identifier (PID), an account funding source (AFS), or any combination thereof.

Clause 17: The method of any of clauses 12-16, wherein the at least one processing option comprises at least one of the following: at least two processing options associated with a same funding source, at least two processing options each associated with a different funding source, or any combination thereof.

Clause 18: The method of any of clauses 12-17, further comprising, before transmitting the modified authorization response message: processing, with at least one processor, the transaction based on the identifier for the funding source and the selected processing option before transmitting the modified authorization response message; and generating, with at least one processor, the modified authorization response message based on processing the transaction.

Clause 19: The method of any of clauses 12-18, further comprising: receiving, by the issuer system, at least one input associated with customized rules from an account holder associated with the first account identifier; determining, by the issuer system, the selected processing option based on the customized rules associated with the account holder; determining, by the issuer system, the funding source compatible with the selected processing option; and generating, by the issuer system, the authorization response message comprising the authorization indicator and the identifier for the funding source compatible with the selected processing option.

Clause 20: A computer program product comprising at least one non-transitory computer-readable medium including program instructions that, when executed by at least one processor, cause the at least one processor to: receive, from an acquirer system, an authorization request message associated with a transaction, the authorization request message comprising a first account identifier; determine that at least one of the transaction, the first account identifier, or any combination thereof qualifies for dynamic processing; identify at least one processing option available for the dynamic processing of the transaction; transmit a modified authorization request message to an issuer system, the modified authorization request message indicating the at least one processing option; receive an authorization response message from the issuer system, the authorization response message comprising an authorization indicator and an identifier for a funding source compatible with a selected processing option of the at least one processing option; and transmit a modified authorization response message based on the authorization indicator and the identifier for the funding source to the acquirer system.

Clause 21: A computer program product comprising at least one non-transitory computer-readable medium including program instructions that, when executed by at least one processor, cause the at least one processor to perform the method of any of clauses 12-19.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of an example payment processing network in which systems, methods, and/or computer program products, described herein, may be implemented, according to some non-limiting embodiments or aspects;

FIG. 2 is a schematic diagram of example components of one or more devices of FIG. 1, according to some non-limiting embodiments or aspects;

FIG. 3 is a flow diagram of an example method for multi account access based on a single credential, according to some non-limiting embodiments or aspects;

FIG. 4 is a schematic diagram of an example implementation of a transaction flow in a system for multi account access based on a single credential, according to some non-limiting embodiments or aspects;

FIG. 5 is a schematic diagram of an example implementation of a transaction flow in a system for multi account access based on a single credential, according to some non-limiting embodiments or aspects;

FIG. 6 is a schematic diagram of an example implementation where a consumer initiates a transaction at a resource provider (e.g., merchant) using a lead credential and has another funding option, according to some non-limiting embodiments or aspects;

FIG. 7 is a schematic diagram of an example implementation where a consumer initiates a transaction at a resource provider (e.g., merchant) using a credential and has multiple processing options associated with the same funding source, according to some non-limiting embodiments or aspects;

FIG. 8 is a schematic diagram of an example implementation where a consumer initiates a transaction at a resource provider (e.g., merchant) using a credential and has multiple alternative processing options, each associated with a different funding source, according to some non-limiting embodiments or aspects;

FIG. 9 is a schematic diagram of an example implementation where a credential is associated with multiple processing options (e.g., payment program identifiers), and each payment option is associated with a different funding source, according to some non-limiting embodiments or aspects;

FIG. 10 is a schematic diagram of an example implementation where a credential is associated with multiple processing options (e.g., payment program identifiers), and each payment option is associated with a different funding source, according to some non-limiting embodiments or aspects;

FIG. 11 is a schematic diagram of an example implementation where a consumer initiates a transaction at a resource provider (e.g., merchant) using a credential and has multiple alternative processing options, according to some non-limiting embodiments or aspects;

FIG. 12 is a schematic diagram of an example implementation of a transaction flow in a system for multi account access based on a single credential, according to some non-limiting embodiments or aspects;

FIG. 13 is a schematic diagram of an example implementation of a transaction flow in a system for multi account access based on a single credential, according to some non-limiting embodiments or aspects;

FIG. 14 is a schematic diagram of an example implementation of a system for multi account access based on a single credential, according to some non-limiting embodiments or aspects;

FIG. 15 is a schematic diagram of an example implementation of a transaction flow in a system for multi account access based on a single credential, according to some non-limiting embodiments or aspects; and

FIG. 16 is a schematic diagram of an example implementation of a clearing/settlement flow in a system for multi account access based on a single credential, according to some non-limiting embodiments or aspects.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

As used herein, the terms “payment token” or “token” may refer to an identifier that is used as a substitute or replacement identifier for an account identifier, such as a PAN. Tokens may be associated with a PAN or other account identifiers in one or more data structures (e.g., one or more databases and/or the like) such that they can be used to conduct a transaction (e.g., a payment transaction) without directly using the account identifier, such as a PAN. In some examples, an account identifier, such as a PAN, may be associated with a plurality of tokens for different individuals, different uses, and/or different purposes. For example, a payment token may include a series of numeric and/or alphanumeric characters that may be used as a substitute for an original account identifier. For example, a payment token “4900 0000 0000 0001” may be used in place of a PAN “4147 0900 0000 1234.” In some non-limiting embodiments or aspects, a payment token may be “format preserving” and may have a numeric format that conforms to the account identifiers used in existing payment processing networks (e.g., ISO 8583 financial transaction message format). In some non-limiting embodiments or aspects, a payment token may be used in place of a PAN to initiate, authorize, settle, or resolve a payment transaction or represent the original credential in other systems where the original credential would typically be provided. In some non-limiting embodiments or aspects, a token value may be generated such that the recovery of the original PAN or other account identifier from the token value may not be computationally derived (e.g., with a one-way hash or other cryptographic function). Further, in some non-limiting embodiments or aspects, the token format may be configured to allow the entity receiving the payment token to identify it as a payment token and recognize the entity that issued the token.

As used herein, the term “provisioning” may refer to a process of enabling a device to use a resource or service. For example, provisioning may involve enabling a device to perform transactions using an account. Additionally or alternatively, provisioning may include adding provisioning data associated with account data (e.g., a payment token representing an account number) to a device.

As used herein, the term “token requestor” may refer to an entity that is seeking to implement tokenization according to embodiments or aspects of the presently disclosed subject matter. For example, the token requestor may initiate a request that a PAN be tokenized by submitting a token request message to a token service provider. Additionally or alternatively, a token requestor may no longer need to store a PAN associated with a token once the requestor has received the payment token in response to a token request message. In some non-limiting embodiments or aspects, the requestor may be an application, a device, a process, or a system that is configured to perform actions associated with tokens. For example, a requestor may request registration with a network token system, request token generation, token activation, token de-activation, token exchange, other token lifecycle management related processes, and/or any other token related processes. In some non-limiting embodiments or aspects, a requestor may interface with a network token system through any suitable communication network and/or protocol (e.g., using HTTPS, SOAP, and/or an XML interface among others). For example, a token requestor may include card-on-file merchants, acquirers, acquirer processors, payment gateways acting on behalf of merchants, payment enablers (e.g., original equipment manufacturers, mobile network operators, and/or the like), digital wallet providers, issuers, third-party wallet providers, payment processing networks, and/or the like. In some non-limiting embodiments or aspects, a token requestor may request tokens for multiple domains and/or channels. Additionally or alternatively, a token requestor may be registered and identified uniquely by the token service provider within the tokenization ecosystem. For example, during token requestor registration, the token service provider may formally process a token requestor's application to participate in the token service system. In some non-limiting embodiments or aspects, the token service provider may collect information pertaining to the nature of the requestor and relevant use of tokens to validate and formally approve the token requestor and establish appropriate domain restriction controls. Additionally or alternatively, successfully registered token requestors may be assigned a token requestor identifier that may also be entered and maintained within the token vault. In some non-limiting embodiments or aspects, token requestor identifiers may be revoked and/or token requestors may be assigned new token requestor identifiers. In some non-limiting embodiments or aspects, this information may be subject to reporting and audit by the token service provider.

As used herein, the term “token service provider” may refer to an entity, including one or more server computers in a token service system that generates, processes, and maintains payment tokens. For example, the token service provider may include or be in communication with a token vault, where the generated tokens are stored. Additionally or alternatively, the token vault may maintain one-to-one mapping between a token and a PAN represented by the token. In some non-limiting embodiments or aspects, the token service provider may have the ability to set aside licensed BINs as token BINs to issue tokens for the PANs that may be submitted to the token service provider. In some non-limiting embodiments or aspects, various entities of a tokenization ecosystem may assume the roles of the token service provider. For example, payment networks and issuers or their agents may become the token service provider by implementing the token services, according to non-limiting embodiments or aspects of the presently disclosed subject matter. Additionally or alternatively, a token service provider may provide reports or data output to reporting tools regarding approved, pending, or declined token requests, including any assigned token requestor ID. The token service provider may provide data output related to token-based transactions to reporting tools and applications and present the token and/or PAN as appropriate in the reporting output. In some non-limiting embodiments or aspects, the EMVCo standards organization may publish specifications defining how tokenized systems may operate. For example, such specifications may be informative, but they are not intended to be limiting upon any of the presently disclosed subject matter.

As used herein, the term “token vault” may refer to a repository that maintains established token-to-PAN mappings. For example, the token vault may also maintain other attributes of the token requestor that may be determined at the time of registration and/or that may be used by the token service provider to apply domain restrictions or other controls during transaction processing. In some non-limiting embodiments or aspects, the token vault may be a part of a token service system. For example, the token vault may be provided as a part of the token service provider. Additionally or alternatively, the token vault may be a remote repository accessible by the token service provider. In some non-limiting embodiments or aspects, token vaults, due to the sensitive nature of the data mappings that are stored and managed therein, may be protected by strong underlying physical and logical security. Additionally or alternatively, a token vault may be operated by any suitable entity, including a payment network, an issuer, clearing houses, other financial institutions, transaction service providers, and/or the like.

Non-limiting embodiments or aspects of the disclosed subject matter are directed to systems, methods, and computer program products for multi account access based on a single credential. For example, non-limiting embodiments or aspects of the disclosed subject matter provide receiving, from an acquirer system, an authorization request message associated with a transaction that includes a first account identifier, determining that at least one of the transaction, the first account identifier, or any combination thereof qualifies for dynamic processing, identifying at least one processing option available for the dynamic processing of the transaction, transmitting a modified authorization request message to an issuer system that indicates the at least one processing option, receiving an authorization response message from the issuer system that includes an authorization indicator and an identifier for a funding source compatible with a selected processing option of the at least one processing option, and transmitting a modified authorization response message based on the authorization indicator and the identifier for the funding source to the acquirer system. As such, the disclosed subject matter enables one or more transactions to be initiated with a single account identifier (e.g., a flexible credential) and have a different account and/or account type to be used to authorize and then settle the transaction. Additionally, the disclosed subject matter allows a user to complete transactions using a plurality of different accounts and/or account types while only needing to carry a single payment device and/or to type in a single account identifier. Moreover, the disclosed subject matter enables the user to set customized rules for selection of which account and/or account type is used for different transactions (e.g., based on customizable criteria). Furthermore, the disclosed subject matter ensures that the same account is used for settlement of the transaction as was used for authorization of the transaction even though the (second) account identifier used to complete the authorization is different than the (first) account identifier in the settlement message due to the storage of the (second) account identifier used to complete the authorization in the separate field of the modified authorization response. In addition, the disclosed subject matter allows for multiple funding sources to be associated with a single credential (e.g., account identifier).

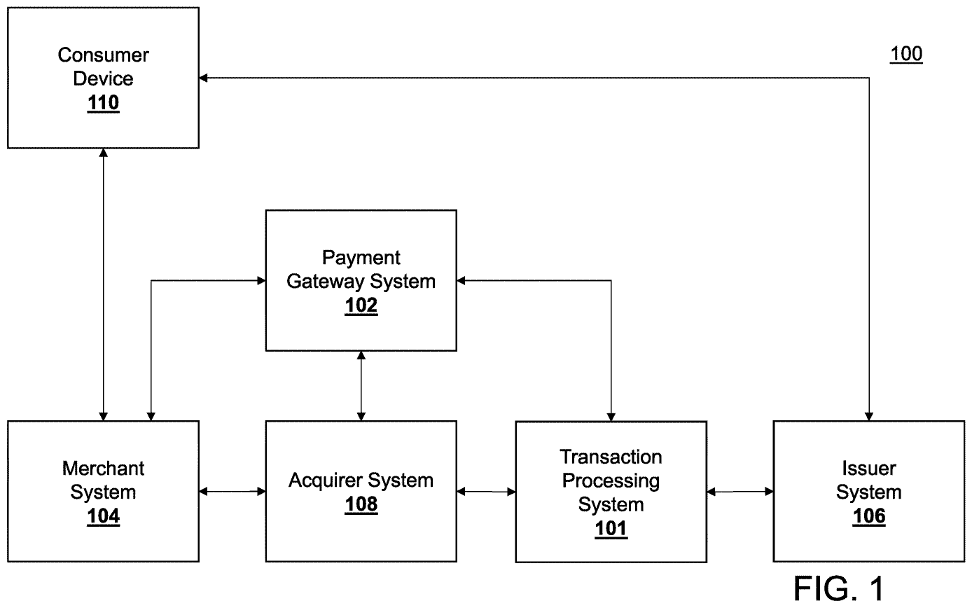

Referring now to FIG. 1, depicted is a diagram of an example payment processing network 100 in which systems, methods, and/or computer program products for multi account access based on a single credential, described herein, may be implemented, according to some non-limiting embodiments or aspects. As shown in FIG. 1, payment processing network 100 may include transaction processing system 101, payment gateway system 102, merchant system 104, issuer system 106, acquirer system 108, and/or consumer device 110.

Transaction processing system 101 may include one or more devices capable of receiving information from and/or communicating information to payment gateway system 102, merchant system 104, issuer system 106, acquirer system 108, consumer device 110, and/or the like (e.g., directly, indirectly, via a public and/or private communication network connection, and/or the like). For example, as shown in FIG. 1, transaction processing system 101 may be in communication with one or more issuer systems (e.g., issuer system 106), one or more acquirer systems (e.g., acquirer system 108), and/or one or more payment gateway systems (e.g., payment gateway system 102). Although only a single issuer system 106, single acquirer system 108, and single payment gateway system 102 are shown, it will be appreciated that transaction processing system 101 may be in communication with a plurality of issuer systems, a plurality of acquirer systems, and/or a plurality of payment gateways. In some non-limiting embodiments or aspects, transaction processing system 101 may include a computing device, such as a server (e.g., a transaction processing server), a group of servers, and/or other like devices. In some non-limiting embodiments or aspects, transaction processing system 101 may be in communication with a data storage device, which may be local or remote to transaction processing system 101. In some non-limiting embodiments or aspects, transaction processing system 101 may be capable of receiving information from, storing information in, communicating information to, or searching information stored in the data storage device. In some non-limiting embodiments or aspects, transaction processing system 101 may be associated with a transaction service provider, as described herein. In some non-limiting embodiments or aspects, transaction processing system 101 may also operate as an issuer system such that both transaction processing system 101 and issuer system 106 are a single system and/or controlled by a single entity.

Payment gateway system 102 may include one or more devices capable of receiving information from and/or communicating information to transaction processing system 101, merchant system 104, issuer system 106, acquirer system 108, consumer device 110, and/or the like (e.g., directly, indirectly, via a public and/or private communication network connection, and/or the like). For example, as shown in FIG. 1, payment gateway system 102 may be in communication with one or more merchant systems (e.g., merchant system 104), one or more acquirer systems (e.g., acquirer system 108), and/or one or more transaction processing systems (e.g., transaction processing system 101). Although only a single merchant system 104, single acquirer system 108, and single transaction processing system 101 are shown, it will be appreciated that payment gateway system 102 may be in communication with a plurality of merchant systems, a plurality of acquirer systems, and/or a plurality of transaction processing systems. In some non-limiting embodiments or aspects, payment gateway system 102 may include a computing device, such as a server, a group of servers, and/or other like devices. In some non-limiting embodiments or aspects, payment gateway system 102 may be associated with a payment gateway, as described herein.

Merchant system 104 may include one or more devices capable of receiving information from and/or communicating information to transaction processing system 101, payment gateway system 102, issuer system 106, acquirer system 108, consumer device 110, and/or the like (e.g., directly, indirectly, via a public and/or private communication network connection, and/or the like). For example, as shown in FIG. 1, merchant system 104 may be in communication with one or more payment gateway systems (e.g., payment gateway system 102), one or more acquirer systems (e.g., acquirer system 108), and/or one or more consumer devices (e.g., consumer device 110). Although only a single payment gateway system 102, single acquirer system 108, and single consumer device 110 are shown, it will be appreciated that merchant system 104 may be in communication with a plurality of payment gateway systems, a plurality of acquirer systems, and/or a plurality of consumer devices. In some non-limiting embodiments or aspects, merchant system 104 may include a computing device, such as a server, a group of servers, a client device, a group of client devices, a POS device, a POS system, computers, computer systems, peripheral devices, and/or other like devices. In some non-limiting embodiments or aspects, merchant system 104 may be associated with a merchant, as described herein. In some non-limiting embodiments or aspects, merchant system 104 may include a device capable of receiving information from and/or communicating information to consumer device 110 via a short range communication connection (e.g., an NFC communication connection, an RFID communication connection, a Bluetooth® communication connection, a Zigbee® communication connection, and/or the like) with consumer device 110 and/or the like. In some non-limiting embodiments or aspects, merchant system 104 may include one or more client devices. For example, merchant system 104 may include a client device that allows a merchant to communicate information to transaction processing system 101 (e.g., via at least one of acquirer system 108 and/or payment gateway system 102). In some non-limiting embodiments or aspects, merchant system 104 (e.g., a client device thereof, a POS device thereof, and/or the like) may also operate as a payment gateway system such that both merchant system 104 and payment gateway system 102 are a single system and/or controlled by a single entity.

Issuer system 106 may include one or more devices capable of receiving information and/or communicating information to transaction processing system 101, payment gateway system 102, merchant system 104, acquirer system 108, consumer device 110, and/or the like (e.g., directly, indirectly, via a public and/or private communication network connection, and/or the like). For example, as shown in FIG. 1, issuer system 106 may be in communication with one or more transaction processing systems (e.g., transaction processing system 101) and/or one or more consumer devices (e.g., consumer device 110). Although only a single transaction processing system 101 and a single consumer device 110 are shown, it will be appreciated that issuer system 106 may be in communication with a plurality of transaction processing systems and/or a plurality of consumer devices 110. In some non-limiting embodiments or aspects, issuer system 106 may include a computing device, such as a server, a group of servers, and/or other like devices. In some non-limiting embodiments or aspects, transaction processing system 101 may be in communication with a data storage device, which may be local or remote to transaction processing system 101. In some non-limiting embodiments or aspects, transaction processing system 101 may be capable of receiving information from, storing information in, communicating information to, or searching information stored in the data storage device. In some non-limiting embodiments or aspects, issuer system 106 may be associated with an issuer institution, as described herein. For example, issuer system 106 may be associated with an issuer institution that issued a credit account, debit account, credit card, debit card, a payment device, and/or the like to a user associated with consumer device 110.

Acquirer system 108 may include one or more devices capable of receiving information from and/or communicating information to transaction processing system 101, payment gateway system 102, merchant system 104, issuer system 106, consumer device 110, and/or the like (e.g., directly, indirectly, via a public and/or private communication network connection, and/or the like). For example, as shown in FIG. 1, acquirer system 108 may be in communication with one or more transaction processing systems (e.g., transaction processing system 101), one or more payment gateway systems (e.g., payment gateway system 102), and/or one or more merchant systems (e.g., merchant system 104). Although only a single transaction processing system 101, a single payment gateway system 102, and a single merchant system 104 are shown, it will be appreciated that acquirer system 108 may be in communication with a plurality of transaction processing systems, a plurality of payment gateway systems, and/or a plurality of merchant systems. In some non-limiting embodiments or aspects, acquirer system 108 may include a computing device, such as a server, a group of servers, and/or other like devices. In some non-limiting embodiments or aspects, acquirer system 108 may be associated with an acquirer institution, as described herein.

Consumer device 110 may include one or more devices capable of receiving information from and/or communicating information to transaction processing system 101, payment gateway system 102, merchant system 104, issuer system 106, acquirer system 108, and/or the like (e.g., directly, indirectly, via a public and/or private communication network connection, and/or the like). For example, as shown in FIG. 1, consumer device 110 may be in communication with one or more merchant systems (e.g., merchant system 104) and/or one or more issuer systems (e.g., issuer system 106). Although only a single merchant system 104 and a single issuer system 106 are shown, it will be appreciated that consumer device 110 may be in communication with a plurality of merchant systems and/or a plurality of issuer systems. In some non-limiting embodiments or aspects, consumer device 110 may be associated with a user to whom a credit account, debit account, credit card, debit card, a payment device, and/or the like has been issued. In some non-limiting embodiments or aspects, user device 110 may include a computing device, such as a computer, a portable computer, a laptop computer, a tablet computers, a mobile device, a cellular phone, a smartphone, a wearable device (e.g., watches, glasses, lenses, clothing, and/or the like), a PDA, a client device, and/or other like devices. In some non-limiting embodiments or aspects, user device 110 may include a payment device, as described herein. In some non-limiting embodiments or aspects, consumer device 110 may include a device capable of receiving information from and/or communicating information to other customer devices 110 (e.g., directly, indirectly, via a public and/or private communication network connection, a short range communication connection, and/or the like). In some non-limiting embodiments or aspects, consumer device 110 may include a device capable of receiving information from and/or communicating information to merchant system 104 via a short range communication connection (e.g., an NFC communication connection, an RFID communication connection, a Bluetooth® communication connection, a Zigbee® communication connection, and/or the like) with merchant system 104 and/or the like. In some non-limiting embodiments or aspects, consumer device 110 may include a client device.

In some non-limiting embodiments or aspects, transaction processing system 101 may communicate with merchant system 104 directly (e.g., via a public and/or private communication network connection and/or the like). Additionally or alternatively, transaction processing system 101 may communicate with merchant system 104 through payment gateway 102 and/or acquirer system 108. In some non-limiting embodiments or aspects, an acquirer system 108 associated with merchant system 104 may operate as payment gateway 102 to facilitate the communication of transaction messages (e.g., authorization requests) from merchant system 104 to transaction processing system 101. In some non-limiting embodiments or aspects, merchant system 104 may communicate with payment gateway 102 directly (e.g., via a public and/or private communication network connection and/or the like). For example, a merchant system 104 that includes a physical POS device may communicate with payment gateway 102 through a public or private network to conduct card-present transactions. As another example, a merchant system 104 that includes a server (e.g., a web server) may communicate with payment gateway 102 through a public or private network, such as the Internet, to conduct card-not-present transactions.

For the purpose of illustration, processing a transaction (e.g., a payment transaction) may include generating a transaction message (e.g., authorization request and/or the like) based on an account identifier of a customer (e.g., accountholder associated with customer device 110 and/or the like) and/or transaction data associated with the transaction. For example, merchant system 104 (e.g., a client device of merchant system 104, a POS device of merchant system 104, and/or the like) may initiate the transaction, e.g., by generating an authorization request (e.g., in response to receiving the account identifier from a payment device and/or a portable financial device of the customer and/or the like). Merchant system 104 may communicate the authorization request to payment gateway 102 and/or acquirer system 108. In some non-limiting embodiments or aspects, payment gateway 102 may communicate the authorization request to acquirer system 108 and/or transaction processing system 101. Additionally or alternatively, acquirer system 108 (and/or payment gateway 102) may communicate the authorization request to transaction processing system 101. After receiving the authorization request from merchant system 104 that identifies the account identifier of the customer (e.g., the accountholder associated with consumer device 110 and/or the account identifier), transaction processing system 101 may communicate the authorization request (or a modified authorization request, as described herein) to issuer system 106 (e.g., the issuer system that issued the payment device and/or account identifier). Issuer system 106 may determine an authorization decision (e.g., approve, deny, and/or the like) based on the authorization request, and/or issuer system 106 may generate an authorization response based on the authorization decision and/or the authorization request. Issuer system 106 may communicate the authorization response to transaction processing system 101. Transaction processing system 101 may communicate the authorization response (or a modified authorization response, as described herein) to acquirer system 108 and/or payment gateway 102. In some non-limiting embodiments or aspects, acquirer system 108 may communicate the authorization response (or modified authorization response) to payment gateway 102 and/or merchant system 104. Additionally or alternatively, payment gateway 102 (and/or acquirer system 108) may communicate the authorization response (or modified authorization response) to merchant system 104.

For the purpose of illustration, clearing and/or settlement of a transaction may include generating a message (e.g., clearing message and/or the like) based on an account identifier of a customer (e.g., associated with customer device 110 and/or the like) and/or transaction data associated with the transaction. For example, merchant system 104 may generate at least one clearing message (e.g., a plurality of clearing messages, a batch of clearing messages, and/or the like). Merchant system 104 may communicate the clearing message(s) to acquirer system 108 (and/or payment gateway 102, which may communicate the clearing message(s) to acquirer system 108). Acquirer system 108 may communicate the clearing message(s) to transaction processing system 101. Transaction processing system 101 may communicate the clearing message(s) to issuer system 106. Issuer system 106 may generate at least one settlement message based on the clearing message(s). In some non-limiting embodiments or aspects, issuer system 106 may communicate the settlement message(s) and/or funds to transaction processing system 101 (and/or a settlement bank system associated with transaction processing system 101), and transaction processing system 101 (and/or the settlement bank system) may communicate the settlement message(s) and/or funds to acquirer system 108. Additionally or alternatively, issuer system 106 may communicate the settlement message(s) and/or funds to acquirer system 108. In some non-limiting embodiments or aspects, acquirer system 108 may communicate settlement message(s) and/or funds to merchant system 104 (and/or an account associated with merchant system 104).

In some non-limiting embodiments or aspects, transaction processing system 101 may receive (e.g., from at least one of acquirer system 108, payment gateway 102, and/or merchant system 104), an authorization request message associated with a transaction. For example, the authorization request message may include a first account identifier. Transaction processing system 101 may determine that at least one of the transaction, the first account identifier, or any combination thereof qualifies for dynamic processing (e.g., deferred processing), as described herein. Transaction processing system 101 may identify at least one processing option available for the dynamic processing of the transaction, as described herein. Transaction processing system 101 may transmit a modified authorization request message to issuer system 106. For example, the modified authorization request message may indicate the at least one processing option, as described herein. Transaction processing system 101 may receive an authorization response message from issuer system 106. For example, the authorization response message may include an authorization indicator and an identifier for a funding source compatible with a selected processing option of the at least one processing option, as described herein. Transaction processing system 101 may transmit a modified authorization response message based on the authorization indicator and the identifier for the funding source (e.g., to at least one of acquirer system 108, payment gateway 102, and/or merchant system 104), as described herein.

In some non-limiting embodiments or aspects, the first account identifier may include a lead credential. For example, the lead credential may identify an accountholder. Additionally or alternatively, the lead credential may identify a default payment account.

In some non-limiting embodiments or aspects, dynamic processing may include deferred processing, as described herein.

In some non-limiting embodiments or aspects, the identifier for the funding source may include a second account identifier. In some non-limiting embodiments or aspects, the identifier for the funding source may include at least one of a product identifier (PID), an account funding source (AFS), or any combination thereof.

In some non-limiting embodiments or aspects, the at least one processing option may include at least two processing options associated with a same funding source. In some non-limiting embodiments or aspects, the at least one processing option comprises at least two processing options each associated with a different funding source.

In some non-limiting embodiments or aspects, transaction processing system 101 may process the transaction based on the identifier for the funding source and the selected processing option (e.g., before transmitting the modified authorization response message). In some non-limiting embodiments or aspects, transaction processing system 101 may generate the modified authorization response message based on processing the transaction (e.g., before transmitting the modified authorization response message).

The systems and/or devices of FIG. 1 may communicate via one or more wired and/or wireless communication networks. For example, the communication network(s) may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems and/or devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems and/or devices shown in FIG. 1 may be implemented within a single system and/or device, or a single system and/or device shown in FIG. 1 may be implemented as multiple, distributed systems and/or devices. Additionally or alternatively, a set of systems (e.g., one or more systems) and/or a set of devices (e.g., one or more devices) of payment processing network 100 may perform one or more functions described as being performed by another set of systems and/or another set of devices of payment processing network 100.

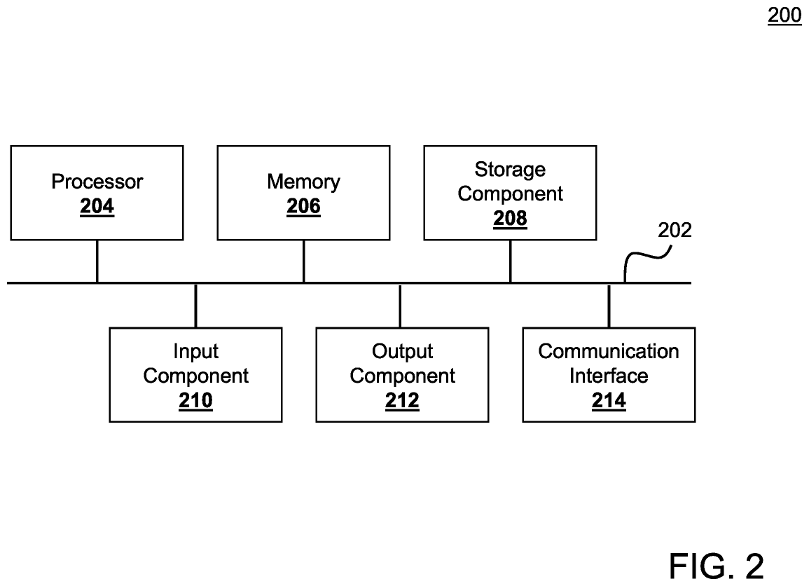

Referring now to FIG. 2, shown is a diagram of example components of a device 200 according to non-limiting embodiments. Device 200 may correspond to transaction processing system 101, payment gateway system 102, merchant system 104, issuer system 106, acquirer system 108, and/or consumer device 110 of FIG. 1, as an example. In some non-limiting embodiments, such systems or devices may include at least one device 200 and/or at least one component of device 200. The number and arrangement of components shown are provided as an example. In some non-limiting embodiments, device 200 may include additional components, fewer components, different components, or differently arranged components than those shown. Additionally or alternatively, a set of components (e.g., one or more components) of device 200 may perform one or more functions described as being performed by another set of components of device 200.

As shown in FIG. 2, device 200 may include bus 202, processor 204, memory 206, storage component 208, input component 210, output component 212, and communication interface 214. Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid-state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

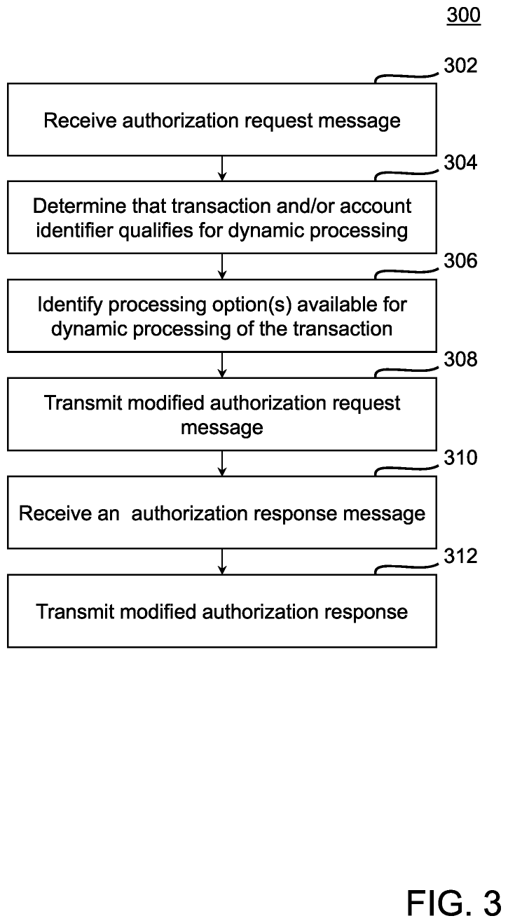

Referring now to FIG. 3, shown is a flow diagram for an example method 300 for multi account access based on a single credential, according to some non-limiting embodiments or aspects. The steps shown in FIG. 3 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of method 300 may be performed (e.g., completely, partially, and/or the like) by transaction processing system 101 (e.g., one or more devices of transaction processing system 101). In some non-limiting embodiments or aspects, one or more of the steps of method 300 may be performed (e.g., completely, partially, and/or the like) by another system, another device, another group of systems, or another group of devices, separate from or including transaction processing system 101, such as payment gateway system 102, merchant system 104, issuer system 106, acquirer system 108, consumer device 110, and/or the like.

As shown in FIG. 3, at step 302, method 300 may include receiving an authorization request message. For example, transaction processing system 101 may receive (e.g., from at least one of acquirer system 108, payment gateway 102, and/or merchant system 104) an authorization request message associated with a transaction. In some non-limiting embodiments or aspects, the authorization request message may include an account identifier (e.g., a first account identifier).

In some non-limiting embodiments or aspects, the first account identifier may include a lead credential, as described herein. For example, the lead credential may identify an accountholder. Additionally or alternatively, the lead credential may identify a default payment account.

As shown in FIG. 3, at step 304, method 300 may include determining that the transaction and/or the account identifier qualifies for dynamic processing. For example, transaction processing system 101 may determine that at least one of the transaction, the first account identifier, or any combination thereof qualifies for dynamic processing.

In some non-limiting embodiments or aspects, dynamic processing may include deferred processing, as described herein.

As shown in FIG. 3, at step 306, method 300 may include identifying at least one processing option available for dynamic processing of the transaction. For example transaction processing system 101 may identify at least one processing option available for the dynamic processing of the transaction.

In some non-limiting embodiments or aspects, the at least one processing option may include at least two processing options associated with a same funding source, as described herein.

In some non-limiting embodiments or aspects, the at least one processing option may include at least two processing options each associated with a different funding source, as described herein.

As shown in FIG. 3, at step 308, method 300 may include transmitting a modified authorization request message. For example, transaction processing system 101 may transmit a modified authorization request message to issuer system 106. In some non-limiting embodiments or aspects, the modified authorization request message may indicate the available processing option(s).

As shown in FIG. 3, at step 310, method 300 may include receiving an authorization response. For example, transaction processing system 101 may receive an authorization response message from issuer system 106. In some non-limiting embodiments or aspects, the authorization response message may include an authorization indicator and an identifier for a funding source compatible with a selected processing option of the at least one processing option.

In some non-limiting embodiments or aspects, the identifier for the funding source may include a second account identifier. Additionally or alternatively, the identifier for the funding source may include at least one of a product identifier (PID), an account funding source (AFS), any combination thereof, and/or the like, as described herein.

In some non-limiting embodiments or aspects, issuer system 106 may determine the selected processing option based on customized rules associated with an account holder associated with the first account identifier. Additionally or alternatively, issuer system 106 may determine the funding source compatible with the selected processing option.

In some non-limiting embodiments or aspects, issuer system 106 may determine an authorization decision (e.g., approve, deny, and/or the like) based on the modified authorization request. For example, the authorization indicator may be associated with the authorization decision.

In some non-limiting embodiments or aspects, issuer system 106 may generate the authorization response message comprising the authorization indicator and the identifier for the funding source compatible with the selected processing option (e.g., before transmitting the authorization response message).

In some non-limiting embodiments or aspects, issuer system 106 may receive at least one input associated with the customized rules from the account holder (e.g., from consumer device 110 associated with the account holder). For example, consumer device 110 may receive the input(s) via an application (e.g., mobile application) on consumer device 110, and consumer device 110 may transmit at least one message based on the input(s) to issuer system 106. In some non-limiting embodiments or aspects, issuer system 106 may receive such input(s) (and/or such message(s) based on such input(s)) before determining the selected payment option and/or generating the authorization response. For example, issuer system 106 may receive such input(s) (and/or such message(s) based on such input(s)) before transaction processing system receives the authorization request message.

In some non-limiting embodiments or aspects, issuer system 106 may determine (e.g., configure) the customized rules based on the input(s). Additionally or alternatively, issuer system 106 may communicate with transaction processing system 106 based on such customized rules. For example, issuer system 106 may communicate at least one communication based on the customized rules. Additionally or alternatively, transaction processing system 301 may determine the transaction and/or account identifier qualifies for dynamic processing based on such customized rules (and/or based on the communication(s)).

As shown in FIG. 3, at step 312, method 300 may include transmitting a modified authorization response message. For example, transaction processing system 101 may transmit a modified authorization response message based on the authorization indicator and the identifier for the funding source (e.g., to at least one of acquirer system 108, payment gateway 102, and/or merchant system 104).

In some non-limiting embodiments or aspects, before transmitting the modified authorization response, transaction processing system 101 may process the transaction based on the identifier for the funding source and the selected processing option. Additionally or alternatively, transaction processing system 101 may generate the modified authorization response message (e.g., based on processing the transaction).

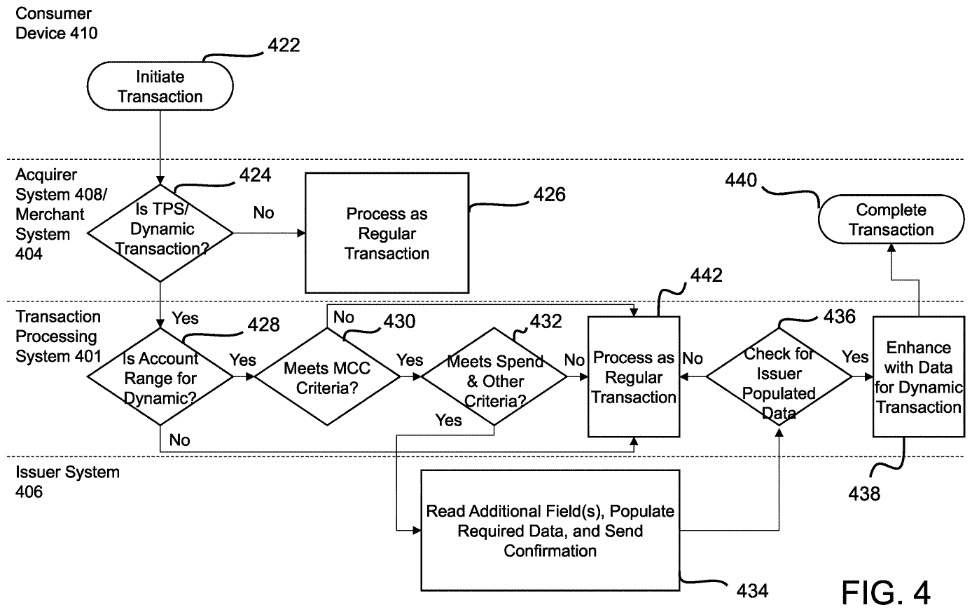

Referring now to FIG. 4, shown is a schematic diagram of an example implementation 400 of a transaction flow in a system for multi account access based on a single credential, according to some non-limiting embodiments or aspects. As shown in FIG. 4, implementation 400 may include consumer device 410, acquirer system 408/merchant system 404, transaction processing system 401, and/or issuer system 406. In some non-limiting embodiments or aspects, consumer device 410 may be the same as or similar to consumer device 110. In some non-limiting embodiments or aspects, acquirer system 408/merchant system 404 may be the same as or similar to acquirer system 108 and/or merchant system 104. In some non-limiting embodiments or aspects, transaction processing system 401 may be the same as or similar to transaction processing system 101. In some non-limiting embodiments or aspects, issuer system 406 may be the same as or similar to issuer system 106. The number and arrangement of systems and/or devices shown in FIG. 4 are provided as an example. There may be additional systems and/or devices, fewer systems and/or devices, different systems and/or devices, and/or differently arranged systems and/or devices than those shown in FIG. 4. Additionally, the steps shown in FIG. 4 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 4, at step 422, a user (e.g., accountholder) may initiate a transaction (e.g., using consumer device 410, a payment device, and/or the like). For example, the user (e.g., accountholder) may present an account identifier (e.g., a credential, such as a lead credential, a modern credential, and/or the like) to a merchant terminal of merchant system 404 (e.g., an in person transaction, a card-present transaction) or to consumer device 410 (e.g., an electronic transaction, a card-not-present transaction, and/or the like). For example, the account identifier (e.g., lead credential) may identify the user.

In some non-limiting embodiments or aspects, the user may have registered multiple programs, accounts, and/or transaction processing rules (e.g., customized rules) with issuer system 406 and/or transaction processing system 401. In some non-limiting embodiments or aspects, issuer system 406 and/or transaction processing system 401 may have set the customized rules.

As shown in FIG. 4, at step 424, acquirer system 408 and/or merchant system 404 may determine whether the transaction is associated with transaction processing system 401 and/or whether the transaction may potentially be processed according to dynamic processing. Additionally or alternatively, the merchant (e.g., merchant system 404) and/or acquirer (e.g., acquirer system 408) may have the option to opt into (or opt out of) dynamic processing. If the transaction is not associated with transaction processing system 401, if the transaction is not eligible for dynamic processing, and/or if the merchant and/or acquirer has opted out of dynamic processing, implementation 400 may proceed to step 426, and the transaction may be processed as a regular transaction (e.g., not including dynamic processing).

In some non-limiting embodiments or aspects, acquirer system 408 and/or merchant system 404 may recognize the account identifier as potentially eligible for dynamic processing (e.g., a lead credential associated with dynamic processing). Acquirer system 408 and/or merchant system 404 may query options (e.g., secondary funding source/account options, processing options, etc.) from transaction processing system 401 (e.g., based on the account identifier/lead credential). For example, such a query may be made using an application programming interface (API) with transaction processing system 401. In some non-limiting embodiments or aspects, the acquirer system 408 and/or merchant system 404 may not be allowed to select the secondary funding source or transaction processing option, but acquirer system 408 and/or merchant system 404 may opt in or opt out after receiving the potential processing options (e.g., based on the query). For example, acquirer system 408 and/or merchant system 404 may determine that the transaction may be processed as an installment transaction, among other options. If acquirer system 408 and/or merchant system 404 does not want the transaction to have the option to be processed as an installment transaction, the merchant may opt out, and request the transaction to be processed using the original or traditional form of funding (e.g., a default payment account). In some non-limiting embodiments or aspects, the merchant may not be given the option to opt in or out.

In some non-limiting embodiments or aspects, merchant system 404 may generate an authorization request message including at least one of the account identifier (e.g., lead credential), a merchant identifier (e.g., merchant ID and/or Visa merchant identifier (VMID)), a merchant category code (MCC), the transaction amount, any combination thereof and/or the like. Merchant system 404 may forward the authorization request message to acquirer system 408. Acquirer system 408 may recognize the account identifier (e.g., a lead credential potentially eligible for dynamic processing) as a potential dynamic transaction (e.g., a transaction that can be processed with a funding source different than the account identifier/lead credential presented and/or accepted when the transaction was initiated).

In some non-limiting embodiments or aspects, acquirer system 408 may transmit the authorization request message to transaction processing system 401.

As shown in FIG. 4, at steps 428-432, transaction processing system 401 may determine whether the account identifier (e.g., lead credential) and/or the transaction is eligible for dynamic processing (e.g., processed with at least one alternative funding source). For example, transaction processing system 401 may determine (e.g., extract, identify, and/or the like) at least one of an account number (e.g., PAN), a bank identification number (e.g., BIN), an MCC and/or merchant identifier (e.g., VMID), associated funding sources/accounts and/or payment programs, transaction amount, any combination thereof, and/or the like (e.g., based on the authorization request message).

As shown in FIG. 4, at step 428, transaction processing system 401 may determine whether the account identifier (e.g., lead credential) is within at least one range associated with dynamic processing. As shown in FIG. 4, at step 430, transaction processing system 401 may determine whether the transaction satisfies MCC criteria (e.g., the MCC of the merchant is eligible for and/or associated with dynamic processing). As shown in FIG. 4, at step 432, transaction processing system 401 may determine whether other criteria (e.g., associated with transaction amount/spending amount, whether the merchant has opted in, whether the user has registered at least one other funding source, etc.) associated with dynamic processing are satisfied. If the account identifier is not within the range, the MCC criteria are not satisfied, and/or the other criteria are not satisfied, implementation 400 may proceed to step 442, and the transaction may be processed as a regular transaction (e.g., not including dynamic processing).

As shown in FIG. 4, at step 434, transaction processing system 401 may communicate with issuer system 406 (e.g., transmit a modified authorization request message including at least one additional field based on the determinations related to eligibility of the account identifier/transaction for dynamic processing) to verify the eligibility criteria and/or obtain other required data for dynamic processing. For example, issuer system 406 may determine (e.g., confirm) that the transaction can be processed as a dynamic transaction (e.g., is eligible based on the account identifier being in the range, the MCC criteria being satisfied, and/or the other criteria being satisfied). For example, issuer system 406 may make such determination based on the modified authorization request (e.g., including reading the additional field(s) thereof).

In some non-limiting embodiments or aspects, the transaction processing system 401 may not have (e.g., may not store) any account identifier(s) for the alternative funding source(s). For example, the transaction processing system 401 may identify the initial account identifier (e.g., lead credential) and/or the transaction as a dynamic transaction, but transaction processing system 401 may not have access to the account identifier for the secondary funding source (e.g., the funding source that will be used to process the transaction). Additionally or alternatively, issuer system 406 may return (e.g., communicate) an identifier for the secondary funding source to transaction processing system 401. For example, issuer system 406 may communicate an authorization response indicating authorization (e.g., including an authorization indicator) to process the transaction using the secondary funding source. The authorization response may include the identifier for the secondary funding source. For example, the lead credential may include at least one of a debit and/or credit account identifier, and the secondary funding source may include an installment payment account (e.g., a buy-now-pay-later (BNPL) account).

As shown in FIG. 4, at step 436, transaction processing system 401 may check to determine (e.g., confirm) that the issuer system 406 provided data required for dynamic processing (e.g., in the authorization response). For example, upon receiving the identifier for the secondary funding source from issuer system 406 (e.g., in the authorization response), transaction processing system 401 may process the transaction with the secondary funding source. For example, transaction processing system 401 may process the transaction as an installment transaction (e.g., a BNPL transaction), for example using a loan funding account (e.g., as such, processing was dynamically switched from the lead (debit and/or credit) credential to the BNPL funding source during the authorization of the transaction). If issuer system 406 did not provide data required for dynamic processing (e.g., in the authorization response), implementation 400 may proceed to step 442, and the transaction may be processed as a regular transaction (e.g., not including dynamic processing).

As shown in FIG. 4, at step 438, transaction processing system 401 may generate a modified authorization response message. For example, transaction processing system 401 may enhance the authorization response message with data associated with the dynamic transaction, such as including an indicator for the outcome of the transaction, including clearing and settlement information regarding the secondary funding source (e.g., an AFS, PID, and/or the like associated with the secondary funding source), and/or the like.

As shown in FIG. 4, at step 440, transaction processing network 401 may transmit the modified authorization response message to acquirer system 408 and/or merchant system 404, which may complete the transaction based on the modified authorization response.

In some non-limiting embodiments or aspects, acquirer system 408 and/or merchant system 404 may initiate (e.g., at a later time) clearing and settlement with the transaction processing system 401 and/or issuer system 406. For example, acquirer system 408 and/or merchant system 404 may communicate at least one clearing message based on the secondary funding source information (e.g., identifier for the secondary funding source from the modified authorization response).

In some non-limiting embodiments or aspects, the identifier for the secondary funding source may not have been communicated to the acquirer system 408 (e.g., not included in the modified authorization response). If so, acquirer system 408 may settle the transaction using an account identifier of the lead credential, any other information that transaction processing system 401 and/or issuer system 406 would have, and/or the like.

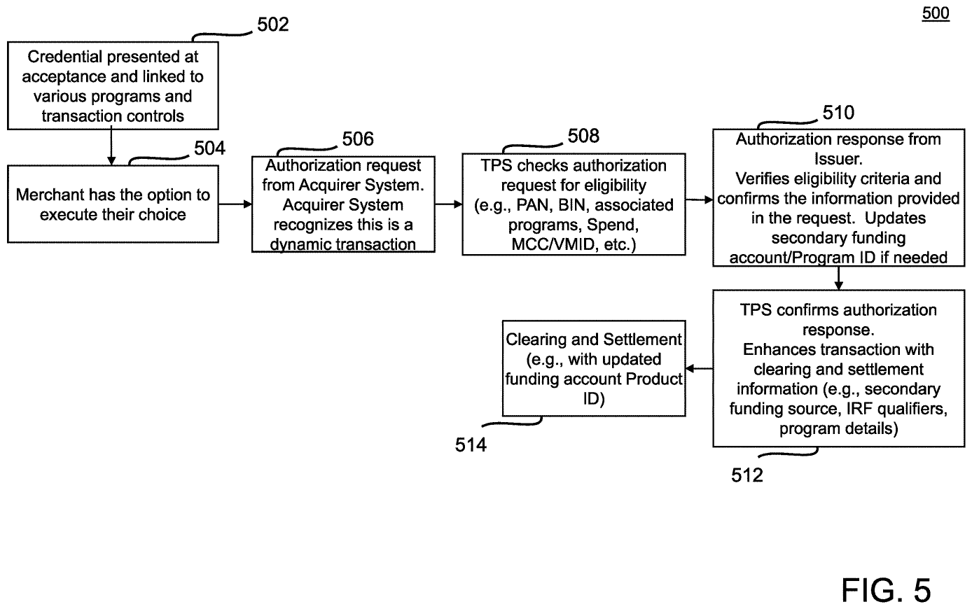

Referring now to FIG. 5, shown is a schematic diagram of an example implementation 500 of a transaction flow in a system for multi account access based on a single credential, according to some non-limiting embodiments or aspects. The steps shown in FIG. 5 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of implementation 500 may be performed (e.g., completely, partially, and/or the like) by transaction processing system 101 (e.g., one or more devices of transaction processing system 101). In some non-limiting embodiments or aspects, one or more of the steps of implementation 500 may be performed (e.g., completely, partially, and/or the like) by another system, another device, another group of systems, or another group of devices, separate from or including transaction processing system 101, such as payment gateway system 102, merchant system 104, issuer system 106, acquirer system 108, consumer device 110, and/or the like.

As shown in FIG. 5, at step 502, a user (e.g., accountholder) may initiate a transaction (e.g., using consumer device 110, a payment device, and/or the like), as described herein. For example, the user (e.g., accountholder) may present an account identifier, as described herein. The account identifier (e.g., lead credential) may be linked to various processing options (e.g., payment programs/program IDs, transaction controls, etc.) and/or secondary funding sources (e.g., based on customized rules), as described herein.

As shown in FIG. 5, at step 504, merchant system 104 (and/or acquirer system 108) may optionally execute a choice (e.g., opt in or opt out) associated with dynamic processing, as described herein.

As shown in FIG. 5, at step 506, merchant system 104 and/or acquirer system 108 may communicate an authorization request, as described herein. In some non-limiting embodiments or aspects, acquirer system 108 may determine (e.g., recognize) that the transaction is potentially a dynamic transaction (e.g., based on the account identifier/lead credential and/or the transaction), as described herein.

As shown in FIG. 5, at step 508, transaction processing system 101 may determine (e.g., check) whether the authorization request message is eligible for dynamic processing (e.g., based on PAN, BIN, associated payment programs, spend criteria, MCC/VMID criteria, and/or the like), as described herein. Transaction processing system 101 may communicate a modified authorization request to issuer system 106.

As shown in FIG. 5, at step 510, issuer system 106 may communicate an authorization response, as described herein. For example, issuer system 106 may verify eligibility criteria, confirm information/data provided in the modified authorization request, and/or determine a secondary funding source, as described herein.

As shown in FIG. 5, at step 512, transaction processing system 101 may confirm the authorization response, as described herein. For example, transaction processing system 101 may check to determine (e.g., confirm) that issuer system 106 provided data required for dynamic processing (e.g., in the authorization response), as described herein.

In some non-limiting embodiments or aspects, transaction processing system 101 may generate a modified authorization response, as described herein. For example, the transaction processing system 101 may generate the modified authorization response by enhancing the authorization response with clearing and/or settlement information (e.g., secondary funding source (e.g., AFS and/or PID), interchange reimbursement fee (IRF) qualifiers (e.g., based on the secondary funding source), payment program details, and/or the like).

As shown in FIG. 5, at step 514, clearing and settlement may be performed (e.g., between acquirer 108, transaction processing system 101, and issuer system 106), as described herein. For example, clearing and settlement may be based on the secondary funding account (e.g., updated and/or substituted with respect to the lead credential) and/or the PID (and/or AFS) associated with the secondary funding account.

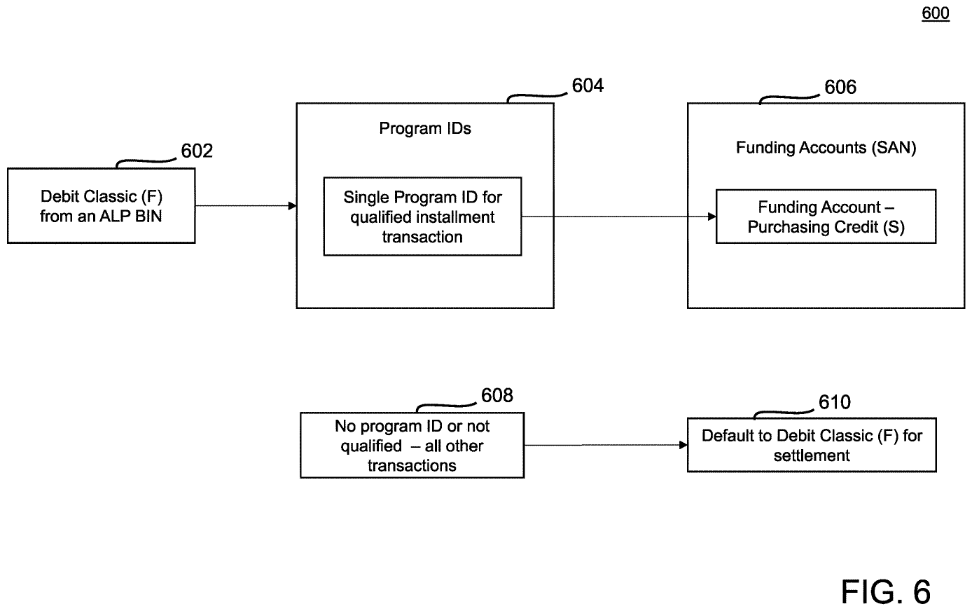

Referring now to FIG. 6, a schematic diagram of an example implementation 600 where a consumer initiates a transaction at a resource provider (e.g., merchant) using a lead credential and has another funding option, according to some non-limiting embodiments or aspects. The steps shown in FIG. 6 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of implementation 600 may be performed (e.g., completely, partially, and/or the like) by transaction processing system 101 (e.g., one or more devices of transaction processing system 101). In some non-limiting embodiments or aspects, one or more of the steps of implementation 600 may be performed (e.g., completely, partially, and/or the like) by another system, another device, another group of systems, or another group of devices, separate from or including transaction processing system 101, such as payment gateway system 102, merchant system 104, issuer system 106, acquirer system 108, consumer device 110, and/or the like.

As shown in FIG. 6, at step 602, the consumer may initiate a transaction at a resource provider (e.g., merchant system 104) using a credential. For example, the credential may be a debit account identifier. In some non-limiting embodiments or aspects, merchant system 104 may generate an authorization request, which may be communicated to transaction processing system 101 (e.g., via acquirer 108), as described herein.

As shown in FIG. 6, at step 604, transaction processing system 101 may determine (e.g., recognize) that the consumer is registered for a single alternative processing option (e.g., a single PID): installment transaction processing. Transaction processing system 101 may determine (e.g., assess) whether the transaction is eligible for installment processing. For example, eligibility rules may indicate that all transactions over a predetermined amount (e.g., $100) should be processed as a BNPL transaction.

In some non-limiting embodiments or aspects, if transaction processing system 101 determines that the transaction is eligible for dynamic processing (e.g., to be processed as an installment/BNPL transaction using a purchasing credit account instead of the initially tendered debit account), transaction processing system 101 may communicate with issuer system 106 (e.g., communicate a modified authorization request to issuer system 106).

As shown in FIG. 6, at step 606, issuer system 106 may determine (e.g., confirm) that the transaction is eligible to be processed as an installment (e.g., BNPL) transaction, and issuer system 106 may determine an account identifier for the secondary funding account (e.g., the purchasing credit account for the installment/BNPL transaction). Issuer system 106 may communicate an authorization response to the transaction processing system 101, as described herein. For example, the authorization response may include an authorization (e.g., authorization indicator) to process the transaction as an installment transaction and/or may include the account identifier of the secondary funding source (e.g., for the installment/BNPL transaction). Transaction processing system 101 may process the transaction and/or communicate a modified authorization response based on the secondary funding source and/or the account identifier thereof, as described herein.

As shown in FIG. 6, at step 608, if transaction processing system 101 determines that the transaction does not meet the eligibility requirements, implementation 600 may proceed to step 610, and transaction processing system 101 may process the transaction using the initially tendered debit account.

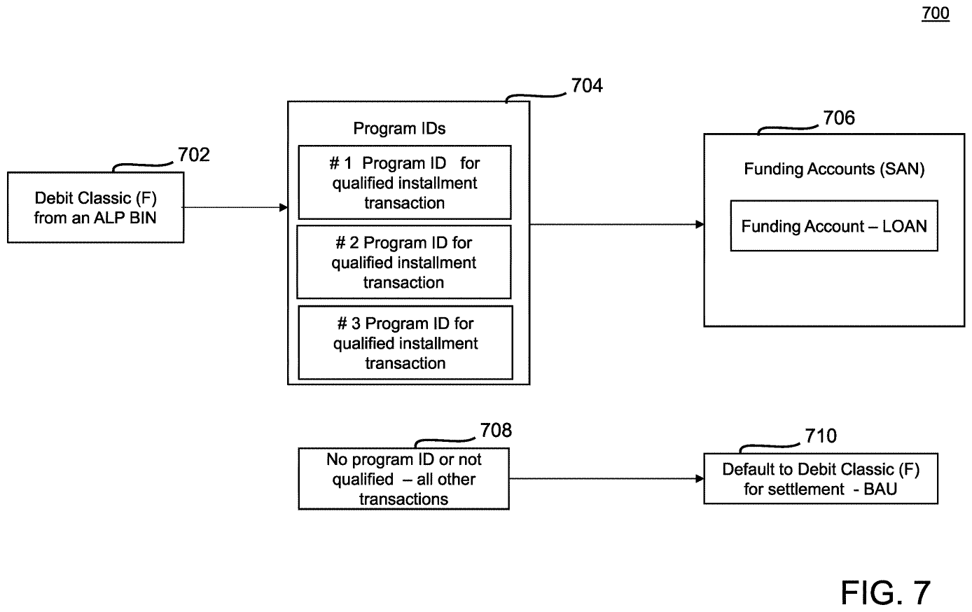

Referring to FIG. 7, shown is a schematic diagram of an example implementation 700 where a consumer initiates a transaction at a resource provider (e.g., merchant) using a credential and has multiple processing options associated with the same funding source, according to some non-limiting embodiments or aspects. The steps shown in FIG. 7 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of implementation 700 may be performed (e.g., completely, partially, and/or the like) by transaction processing system 101 (e.g., one or more devices of transaction processing system 101). In some non-limiting embodiments or aspects, one or more of the steps of implementation 700 may be performed (e.g., completely, partially, and/or the like) by another system, another device, another group of systems, or another group of devices, separate from or including transaction processing system 101, such as payment gateway system 102, merchant system 104, issuer system 106, acquirer system 108, consumer device 110, and/or the like.

As shown in FIG. 7, at step 702, the consumer may initiate a transaction at a resource provider (e.g., merchant system 104) using a credential. For example, the credential may be a debit account identifier. In some non-limiting embodiments or aspects, merchant system 104 may generate an authorization request, which may be communicated to transaction processing system 101 (e.g., via acquirer 108), as described herein.

As shown in FIG. 7, at step 704, transaction processing system 101 may determine (e.g., recognize) that the user is registered for multiple alternative processing options (e.g., multiple PIDs): a first installment transaction option, a second installment transaction option, and a third installment transaction option. Each option may have respective (e.g., unique) installment terms (e.g., 2 months, 5 months, and 10 months, respectively) and/or respective (e.g., unique) interest rates. Transaction processing system 101 may assess which option is available for the transaction (e.g., based on the customized rules for the consumer and/or the like). In some non-limiting embodiments or aspects, all of the options (or a subset of the options) may be associated with the same funding account (e.g., the secondary funding account, which may be a loan account) even though each option is associated with different installment processing rules (e.g., terms, interest rates, etc.). In some non-limiting embodiments or aspects, if transaction processing system 101 determines that the transaction is eligible for dynamic processing (e.g., processing as a dynamic transaction), transaction processing system 101 may communicate a modified authorization request, e.g., including a PID for one or more of the available options, to issuer system 106.

As shown in FIG. 7, at step 706, issuer system 106 may determine (e.g., confirm) that the transaction is eligible to be processed as an installment transaction and/or may select one of the options (e.g., the second option), for example, based on customized rules of the user/consumer, as described herein. Issuer system 106 may communicate an authorization response to the transaction processing system 101, as described herein. For example, the authorization response may include an authorization (e.g., authorization indicator) to process the transaction as an installment transaction and/or may include an identifier for the secondary funding account (e.g., the loan account associated with the second option). Transaction processing system 101 may process the transaction and/or communicate a modified authorization response based on the secondary funding source and/or the account identifier thereof, as described herein.

As shown in FIG. 7, at step 708, if transaction processing system 101 determines that the transaction does not meet the eligibility requirements, implementation 700 may proceed to step 710, and transaction processing system 101 may process the transaction using the initially tendered debit account.

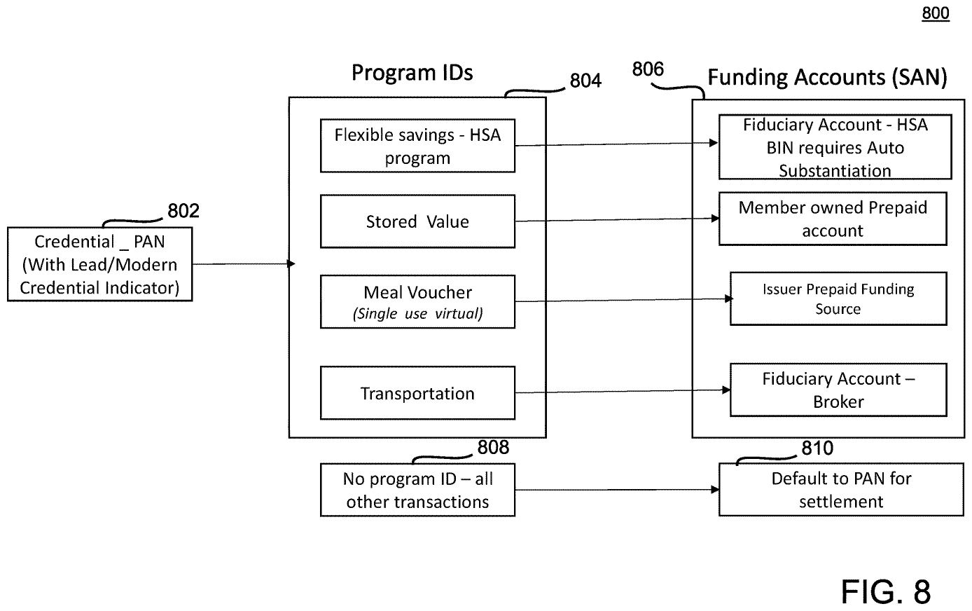

Referring now to FIG. 8, shown is a schematic diagram of an example implementation 800 where a consumer initiates a transaction at a resource provider (e.g., merchant) using a credential and has multiple alternative processing options, each associated with a different funding source, according to some non-limiting embodiments or aspects. The steps shown in FIG. 8 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of implementation 800 may be performed (e.g., completely, partially, and/or the like) by transaction processing system 101 (e.g., one or more devices of transaction processing system 101). In some non-limiting embodiments or aspects, one or more of the steps of implementation 800 may be performed (e.g., completely, partially, and/or the like) by another system, another device, another group of systems, or another group of devices, separate from or including transaction processing system 101, such as payment gateway system 102, merchant system 104, issuer system 106, acquirer system 108, consumer device 110, and/or the like.

As shown in FIG. 8, at step 802, the consumer may initiate a transaction at a resource provider (e.g., merchant system 104) using a credential. For example, the credential may be a PAN associated with a lead credential indicator (e.g., a modern credential indicator). In some non-limiting embodiments or aspects, merchant system 104 may generate an authorization request, which may be communicated to transaction processing system 101 (e.g., via acquirer 108), as described herein.

As shown in FIG. 8, at step 804, transaction processing system 101 may determine (e.g., recognize) that the user is registered for multiple alternative processing options (e.g., multiple PIDs): a flexible savings account program, a stored value option, a meal voucher option, and a transportation program option. Each option may have unique requirements. In some non-limiting embodiments or aspects, the available options may include and/or be associated with employee benefits, where each benefit is funded by a different funding source. Transaction processing system 101 may determine (e.g., assess) which option(s) is/are available for the transaction (e.g., based on customized rules, as described herein). In some embodiments, each option may be associated with a different funding account (e.g., the secondary funding account), such as a first fiduciary account (e.g., healthcare savings account (HAS)), a member owned prepaid account, an issuer prepaid funding source, and a second fiduciary account (e.g., a brokerage account), respectively. In some non-limiting embodiments or aspects, if transaction processing system 101 determines that the transaction is eligible for dynamic processing (e.g., processing as a dynamic transaction), transaction processing system 101 may communicate a modified authorization request, e.g., including a PID for one or more of the available options, to issuer system 106.

As shown in FIG. 8, at step 806, issuer system 106 may determine (e.g., confirm) that the transaction is eligible to be processed as a dynamic transaction (e.g., using one of the available options), for example, based on customized rules of the user/consumer, as described herein. Issuer system 106 may communicate an authorization response to the transaction processing system 101, as described herein. For example, the authorization response may include the identifier for the secondary funding account associated with the appropriate (e.g., selected) option. The authorization response may include an authorization (e.g., authorization indicator) to process the transaction as a dynamic transaction (e.g., process the transaction pursuant to the available/selected option) and/or may include an identifier for the secondary funding account. Transaction processing system 101 may process the transaction and/or communicate a modified authorization response based on the secondary funding source and/or the account identifier thereof, as described herein.

For example, the user may conduct a transaction at a pharmacy. When the user tenders the payment device including the lead credential, the transaction may be processed using the HSA account. If there are items on the transaction that do not qualify for HSA transaction, those items may be processed using the prepaid account. The user may use the same payment device at an approved meal voucher restaurant, and purchase food using the issue prepaid funding source.

As shown in FIG. 8, at step 808, if transaction processing system 101 determines that the transaction does not meet the eligibility requirements, implementation 800 may proceed to step 810, and transaction processing system 101 may process the transaction using the initially tendered PAN (e.g., as a default payment account).

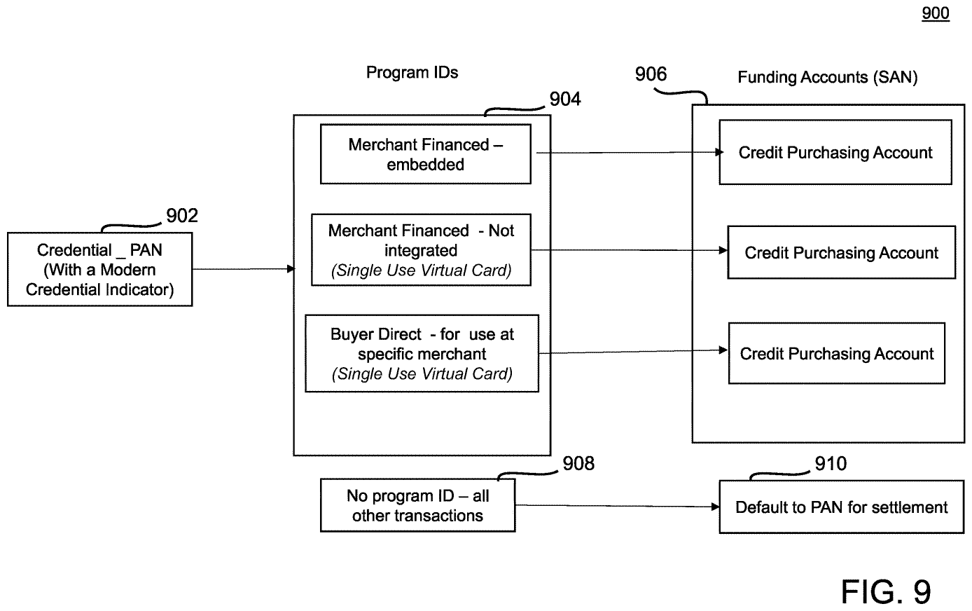

Referring now to FIG. 9, shown is a schematic diagram of an example implementation 900 where a credential is associated with multiple processing options (e.g., payment program identifiers), and each payment option is associated with a different funding source, according to some non-limiting embodiments or aspects. The steps shown in FIG. 9 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of implementation 900 may be performed (e.g., completely, partially, and/or the like) by transaction processing system 101 (e.g., one or more devices of transaction processing system 101). In some non-limiting embodiments or aspects, one or more of the steps of implementation 900 may be performed (e.g., completely, partially, and/or the like) by another system, another device, another group of systems, or another group of devices, separate from or including transaction processing system 101, such as payment gateway system 102, merchant system 104, issuer system 106, acquirer system 108, consumer device 110, and/or the like.

As shown in FIG. 9, at step 902, the consumer may initiate a transaction at a resource provider (e.g., merchant system 104) using a credential. For example, the credential may be a PAN associated with a lead credential indicator (e.g., a modern credential indicator). In some non-limiting embodiments or aspects, merchant system 104 may generate an authorization request, which may be communicated to transaction processing system 101 (e.g., via acquirer 108), as described herein.

As shown in FIG. 9, at step 904, transaction processing system 101 may determine (e.g., recognize) that the user is registered for multiple alternative processing options (e.g., multiple PIDs), as described herein. Transaction processing system 101 may determine (e.g., assess) which option(s) is/are available for the transaction (e.g., based on customized rules, as described herein). In some non-limiting embodiments or aspects, if transaction processing system 101 determines that the transaction is eligible for dynamic processing (e.g., processing as a dynamic transaction), transaction processing system 101 may communicate a modified authorization request, e.g., including a PID for one or more of the available options, to issuer system 106.

As shown in FIG. 9, at step 906, issuer system 106 may determine (e.g., confirm) that the transaction is eligible to be processed as a dynamic transaction (e.g., using one of the available options), for example, based on customized rules of the user/consumer, as described herein. Issuer system 106 may communicate an authorization response to the transaction processing system 101, as described herein. For example, the authorization response may include the identifier for the secondary funding account associated with the appropriate (e.g., selected) option, as described herein. Transaction processing system 101 may process the transaction and/or communicate a modified authorization response based on the secondary funding source and/or the account identifier thereof, as described herein.

As shown in FIG. 9, at step 908, if transaction processing system 101 determines that the transaction does not meet the eligibility requirements, implementation 900 may proceed to step 910, and transaction processing system 101 may process the transaction using the initially tendered PAN (e.g., as a default payment account).

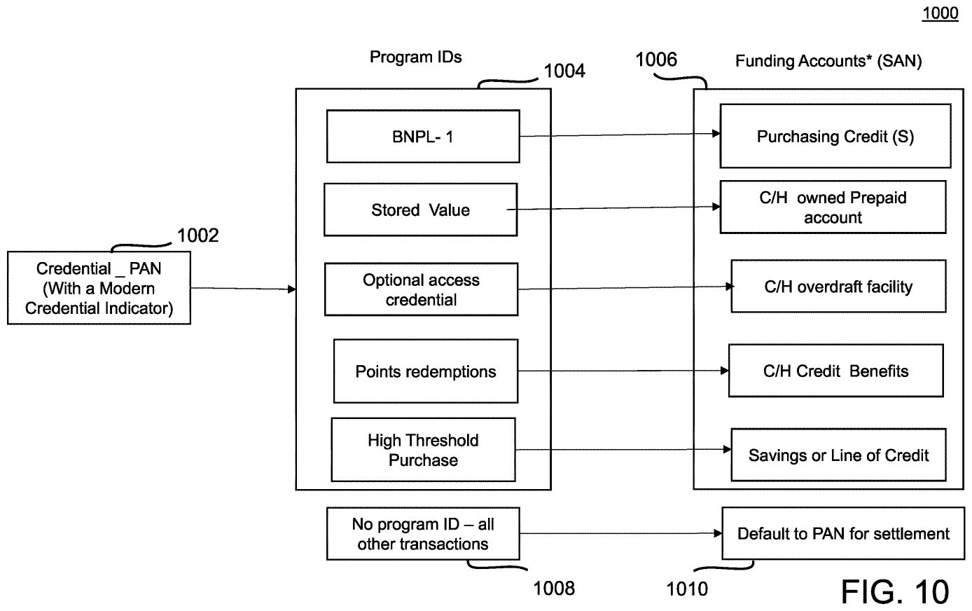

Referring now to FIG. 10, shown is a schematic diagram of an example implementation 1000 where a credential is associated with multiple processing options (e.g., payment program identifiers), and each payment option is associated with a different funding source, according to some non-limiting embodiments or aspects. The steps shown in FIG. 10 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of implementation 1000 may be performed (e.g., completely, partially, and/or the like) by transaction processing system 101 (e.g., one or more devices of transaction processing system 101). In some non-limiting embodiments or aspects, one or more of the steps of implementation 1000 may be performed (e.g., completely, partially, and/or the like) by another system, another device, another group of systems, or another group of devices, separate from or including transaction processing system 101, such as payment gateway system 102, merchant system 104, issuer system 106, acquirer system 108, consumer device 110, and/or the like.

As shown in FIG. 10, at step 1002, the consumer may initiate a transaction at a resource provider (e.g., merchant system 104) using a credential. For example, the credential may be a PAN associated with a lead credential indicator (e.g., a modern credential indicator). In some non-limiting embodiments or aspects, merchant system 104 may generate an authorization request, which may be communicated to transaction processing system 101 (e.g., via acquirer 108), as described herein.

As shown in FIG. 10, at step 1004, transaction processing system 101 may determine (e.g., recognize) that the user is registered for multiple alternative processing options (e.g., multiple PIDs), as described herein. Transaction processing system 101 may determine (e.g., assess) which option(s) is/are available for the transaction (e.g., based on customized rules, as described herein). In some non-limiting embodiments or aspects, if transaction processing system 101 determines that the transaction is eligible for dynamic processing (e.g., processing as a dynamic transaction), transaction processing system 101 may communicate a modified authorization request, e.g., including a PID for one or more of the available options, to issuer system 106.

As shown in FIG. 10, at step 1006, issuer system 106 may determine (e.g., confirm) that the transaction is eligible to be processed as a dynamic transaction (e.g., using one of the available options), for example, based on customized rules of the user/consumer, as described herein. Issuer system 106 may communicate an authorization response to the transaction processing system 101, as described herein. For example, the authorization response may include the identifier for the secondary funding account associated with the appropriate (e.g., selected) option, as described herein. Transaction processing system 101 may process the transaction and/or communicate a modified authorization response based on the secondary funding source and/or the account identifier thereof, as described herein.

As shown in FIG. 10, at step 1008, if transaction processing system 101 determines that the transaction does not meet the eligibility requirements, implementation 900 may proceed to step 910, and transaction processing system 101 may process the transaction using the initially tendered PAN (e.g., as a default payment account).

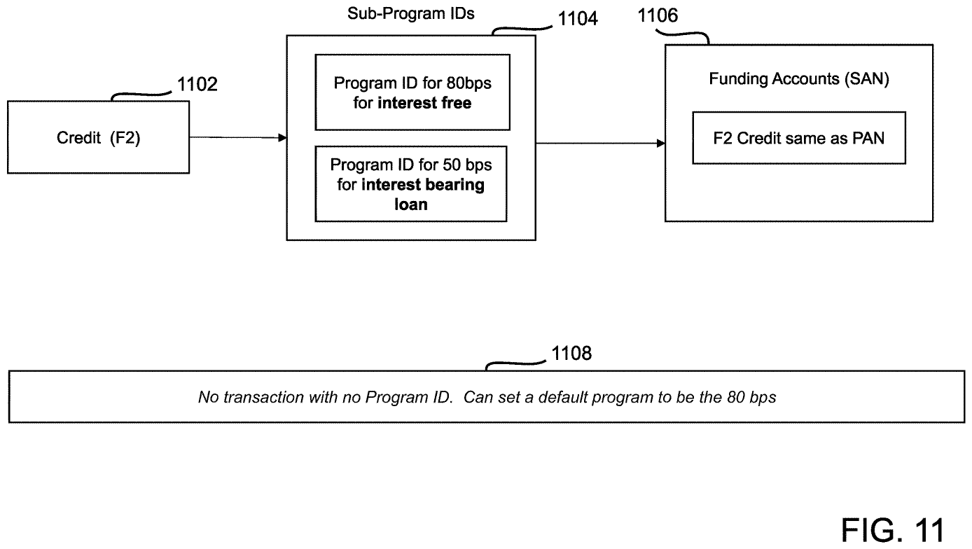

Referring now to FIG. 11, shown is a schematic diagram of an example implementation where a consumer initiates a transaction at a resource provider (e.g., merchant) using a credential and has multiple alternative processing options, according to some non-limiting embodiments or aspects. The steps shown in FIG. 11 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of implementation 1100 may be performed (e.g., completely, partially, and/or the like) by transaction processing system 101 (e.g., one or more devices of transaction processing system 101). In some non-limiting embodiments or aspects, one or more of the steps of implementation 1100 may be performed (e.g., completely, partially, and/or the like) by another system, another device, another group of systems, or another group of devices, separate from or including transaction processing system 101, such as payment gateway system 102, merchant system 104, issuer system 106, acquirer system 108, consumer device 110, and/or the like.

As shown in FIG. 11, at step 1102, the consumer may initiate a transaction at a resource provider (e.g., merchant system 104) using a credential. For example, the credential may be a credit account identifier. In some non-limiting embodiments or aspects, merchant system 104 may generate an authorization request, which may be communicated to transaction processing system 101 (e.g., via acquirer 108), as described herein.

As shown in FIG. 10, at step 1004, transaction processing system 101 may determine (e.g., recognize) that the user is registered for multiple alternative processing options (sub-PIDs): a first credit transaction option and a second credit transaction option. Each option may have unique terms (e.g., interest rates). Transaction processing system 101 may determine (e.g., assess) which option is available to the transaction (e.g., based on customized rules, as described herein). In some non-limiting embodiments or aspects, both options may be associated with the same funding account (e.g., the credit account) even though each option is associated with different processing rules (e.g., terms, interest rates, etc.). For example, while the funding source may be the same, the transaction details may determine whether the transaction qualifies for the first option or the second option.

In some non-limiting embodiments or aspects, if transaction processing system 101 determines that the transaction is eligible for dynamic processing (e.g., processing as a dynamic transaction), transaction processing system 101 may communicate a modified authorization request, e.g., including a sub-PID for one or more of the available options, to issuer system 106.

As shown in FIG. 11, at step 1106, issuer system 106 may determine (e.g., confirm) that the transaction is eligible to be processed as a dynamic transaction (e.g., using one of the available options, such as the second option). Issuer system 106 may determine (e.g., obtain) an identifier for the credit funding account. Issuer system 106 may communicate an authorization response to the transaction processing system 101, as described herein. For example, the authorization response may include an authorization (e.g., authorization indicator) to process the transaction using the selected (e.g., second) option, and the authorization response may include the account identifier for the secondary funding source (e.g., the credit funding account). Transaction processing system 101 may process the transaction and/or communicate a modified authorization response based on the secondary funding source and/or the account identifier thereof, as described herein.

As shown in FIG. 11, at step 1108, transaction processing system 101 may process the transaction using one of the options (e.g., the first option) as a default payment account.

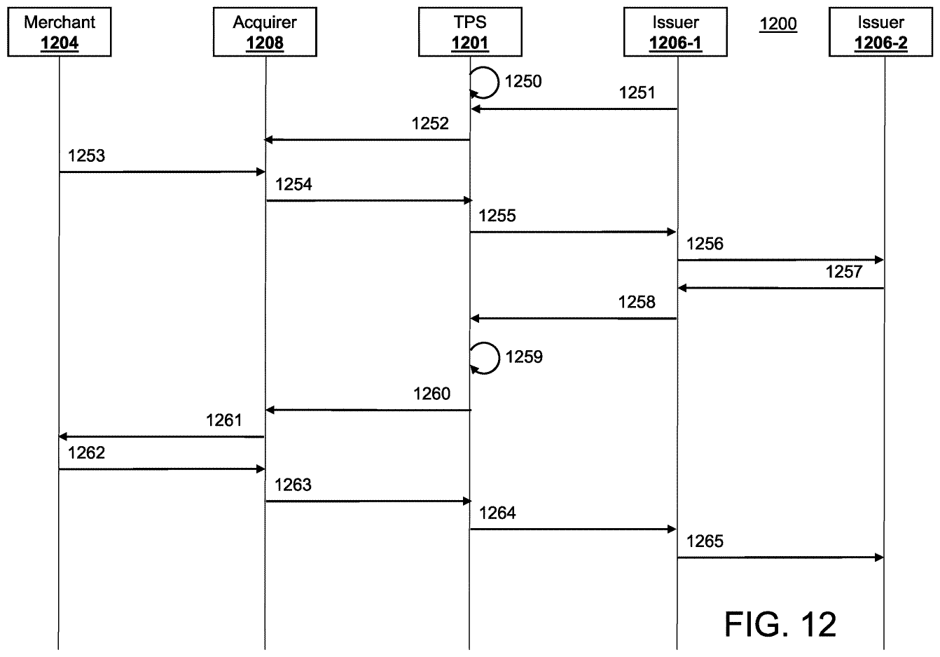

Referring now to FIG. 12, shown is a schematic diagram of an example implementation 1200 of a transaction flow in a system for multi account access based on a single credential, according to some non-limiting embodiments or aspects. The steps shown in FIG. 12 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown in FIG. 12, implementation 1200 may include merchant system 1204, acquirer system 1208, transaction processing system 1201, and at least one issuer system (e.g., first issuer system 1206-1 and second issuer system 1206-2). In some non-limiting embodiments or aspects, merchant system 1204 may be the same as or similar to merchant system 104. In some non-limiting embodiments or aspects, acquirer system 1208 may be the same as or similar to acquirer system 108. In some non-limiting embodiments or aspects, transaction processing system 1201 may be the same as or similar to transaction processing system 101. In some non-limiting embodiments or aspects, first issuer system 1206-1 and/or second issuer system 1206-2 may be the same as or similar to issuer system 106. In some non-limiting embodiments or aspects, first issuer system 1206-1 and second issuer system 1206-2 may be associated with the same issuer institution and/or be the same issuer system. In some non-limiting embodiments or aspects, first issuer system 1206-1 and second issuer system 1206-2 may be associated with different issuer institutions and/or be separate issuer systems. The number and arrangement of systems and/or devices shown in FIG. 12 are provided as an example. There may be additional systems and/or devices, fewer systems and/or devices, different systems and/or devices, and/or differently arranged systems and/or devices than those shown in FIG. 12.

As shown in FIG. 12, at step 1200, transaction processing system 1201 may configure the system (e.g., configure itself) for dynamic transaction processing. For example, at least one debit account identifier may be selected as a lead credential, and at least one processing option (e.g., alternative processing option associated with a secondary funding source) may be initialized as a loan/purchasing credit account (e.g., for an installment payment and/or BNPL transaction). As such, when a user presents a debit account identifier (e.g., a debit card and/or an account identifier including a debit BIN), transaction processing system 1201 may determine (e.g., assess) whether the transaction is eligible for dynamic processing (e.g., processing the eligible transaction using the alternative funding source, such as the purchasing credit account for installment payments/BNPL).

As shown in FIG. 12, at step 1251, transaction processing system 1201 may set the account level processing (ALP) flag of an account range definition (ARDEF) file may be is set to Y (e.g., yes), which may indicate to acquirer system 1208 that the PID and the funding source (e.g., AFS) may change during authorization of the transaction. In some non-limiting embodiments or aspects, first issuer system 1206-1 (e.g., the issuer system that issued the debit account) may communicate at least one BIN or at least one range of BINs to transaction processing system 1201.

As shown in FIG. 12, at step 1252, transaction processing system 1201 may communicate (e.g., transmit) the ARDEF file to acquirer system 1208.

As shown in FIG. 12, at step 1253, the cardholder may initiate a transaction using the lead (e.g., debit) credential (e.g., presenting and/or communicating the lead credential to merchant system 1204). Merchant system 1204 may generate an authorization request based on the lead credential and/or communicate the authorization request to acquirer system 1204. The authorization request may also include an identifier of the merchant (e.g., merchant ID and/or VMID).

As shown in FIG. 12, at step 1254, acquirer system 1204 may communicate the authorization request to transaction processing system 1201. For example, acquirer system 1208 may use the ARDEF file to determine that the authorization request should be routed to transaction processing system 1201.

As shown in FIG. 12, at step 1255, transaction processing system 1201 may determine (e.g., analyze) whether the transaction is eligible for dynamic processing (e.g., deferred processing, such as BNPL processing), as described herein. If the transaction is not eligible, it may be processed as a regular (e.g., debit) transaction. If the transaction is eligible, transaction processing system 1201 may generate a modified authorization request. For example, the authorization request may be modified by populating a dedicated field (e.g., field 62.25) with an indicator that the transaction is eligible for dynamic processing and/or that eligibility criteria have been met. Additionally or alternatively, the authorization request may be modified by populating a dedicated field (e.g., field 62.23) with a PID. In some non-limiting embodiments or aspects, transaction processing system 1202 may communicate the modified authorization request to first issuer system 1206-1 (e.g., communicate the modified authorization request to the issuer system that issued the debit account).

As shown in FIG. 12, at step 1256, first issuer system 1206-1 confirms the transaction is eligible for processing as a dynamic transaction, as described herein. If so, in some non-limiting embodiments or aspects, first issuer system 1206-1 may communicate a request (e.g., the modified authorization request, a further modified authorization request, and/or the like) to second issuer system 1206-2 (e.g., an issuer associated with a loan/BNPL account). Second issuer system 1206-2 may determine whether the transaction is eligible for dynamic processing (e.g., based on customized rules for the user, as described herein).

As shown in FIG. 12, at step 1257, second issuer system 1206-2 may communicate a confirmation to first issuer system 1206-1 indicating whether or not the transaction is eligible/will be processed as a dynamic transaction. If not, the transaction will be processed as a regular (e.g., debit) transaction. If the transaction is eligible/will be processed as a dynamic transaction, the confirmation may include additional data regarding the funding source (e.g., PID, payment terms, and/or the account identifier of the funding source). As such, the transaction may be dynamically switched from a debit transaction to a deferred (e.g., BNPL) transaction.

As shown in FIG. 12, at step 1258, first issuer system 1206-1 communicates an authorization response to transaction service provider system. If the transaction was not eligible/will not be processed as a dynamic transaction, the authorization response will be a regular (e.g., debit) transaction authorization response. If the transaction is eligible/will be processed as a dynamic transaction, first issuer system 1206-1 may populate additional fields in the authorization response. For example, first issuer system 1206-1 may populate field 62.24 based on the PID, field 102 based on the payment terms (e.g., Field 102=FNO PAN), and/or field 104 DS-5D based on tags (e.g., tags 03, 06-08, and 17) associated with dynamic processing.

As shown in FIG. 12, at step 1259, transaction processing system 1201 may determine (e.g., check) that the issuer system 1206 provided data required for dynamic processing (e.g., in the authorization response). If so, transaction processing system 1201 may process the transaction based on the secondary funding source (e.g., for qualified transactions).

As shown in FIG. 12, at step 1260, transaction processing system 1201 may transmit a modified authorization response to acquirer system 1208, as described herein. For example, transaction processing system 1201 may modify the authorization response by populating additional fields with data useful (e.g., required) for clearing and settlement based on the secondary funding source (e.g., ACI (field 62.1)=T, field 62.23=S (purchasing credit for loan/BNPL account), field 62.24=6DigitalAN, field 62.25=B). In some non-limiting embodiments or aspects, transaction processing system 1201 may calculate a Val code. In some non-limiting embodiments or aspects, transaction processing system 1201 may modify the authorization response by dropping at least one field (e.g., field 104 DS5D). If the transaction does not qualify for dynamic processing, the transaction may be processed as a regular (e.g., debit) transaction.

As shown in FIG. 12, at step 1261, acquirer system 1208 may communicate the (modified) authorization response to merchant system 1204.

As shown in FIG. 12, at step 1262, merchant system 1204 may communicate a clearing message (e.g., an end of day (EOD) capture message) to acquirer system 1208.

As shown in FIG. 12, at step 1263, acquirer system 1208 may communicate a clearing message based on the secondary funding account to transaction processing system 1201.

As shown in FIG. 12, at steps 1264 and 1265, transaction processing system 1201 may communicate a clearing message to first issuer system 1206-1 and/or second issuer system 1206-2. For example, transaction processing system 1201 may perform a VAL code check and/or determine an IRF based on the secondary funding account. In some non-limiting embodiments or aspects, transaction processing system 1201 may clear and/or settle the transaction based on the secondary funding account.

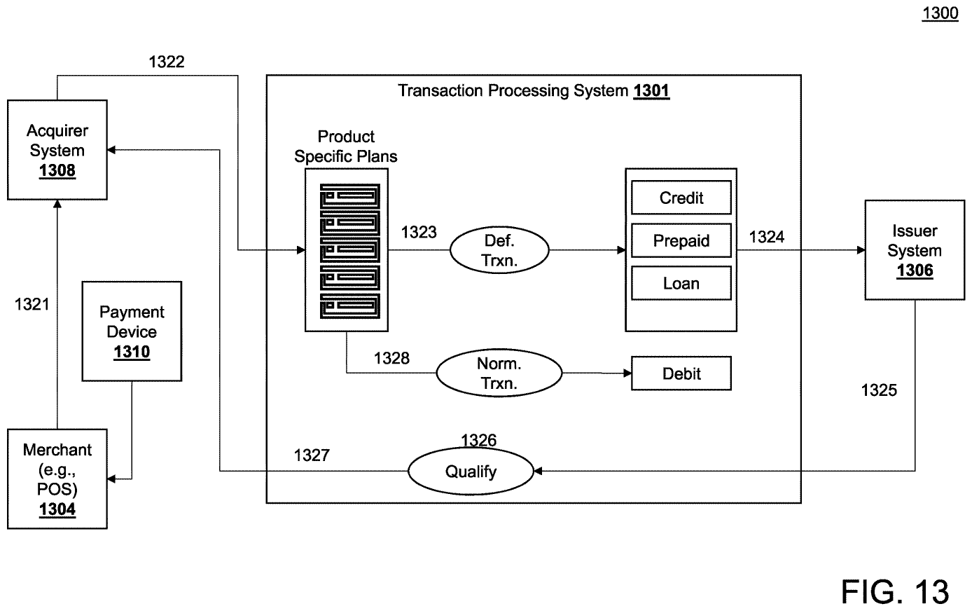

Referring now to FIG. 13, shown is a schematic diagram of an example implementation 1300 of a transaction flow in a system for multi account access based on a single credential, according to some non-limiting embodiments or aspects. The steps shown in FIG. 13 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown in FIG. 13, implementation 1300 may include payment device 1310, merchant system 1304, acquirer system 1308, transaction processing system 1301, and issuer system 1306. In some non-limiting embodiments or aspects, payment device 1310 may be the same as or similar to consumer device 110. In some non-limiting embodiments or aspects, merchant system 1304 may be the same as or similar to merchant system 104. In some non-limiting embodiments or aspects, acquirer system 1308 may be the same as or similar to acquirer system 108. In some non-limiting embodiments or aspects, transaction processing system 1301 may be the same as or similar to transaction processing system 101. In some non-limiting embodiments or aspects, issuer system 1306 may be the same as or similar to issuer system 106. The number and arrangement of systems and/or devices shown in FIG. 13 are provided as an example. There may be additional systems and/or devices, fewer systems and/or devices, different systems and/or devices, and/or differently arranged systems and/or devices than those shown in FIG. 13.

As shown in FIG. 13, at step 1321, after a user presents payment device 1310 (e.g., a debit BIN or a debit card) to merchant system 1304 (e.g., a POS device/terminal thereof), merchant system 1304 may transmits an authorization request message to acquirer 1308, as described herein. For example, the authorization request message may include transaction information (e.g., transaction amount, merchant ID, MCC) as well as an account identifier associated with payment device 1310.

As shown in FIG. 13, at step 1322, acquirer system 1308 may sends the authorization request message (and/or data associated therewith) to transaction processing system 1301.

As shown in FIG. 13, at step 1323, transaction processing system 1301 may determine (e.g., analyze) whether the transaction is eligible for dynamic processing (e.g., based on customized rules and/or product-specific plans), as described herein. For example, transaction processing system 1301 may identify at least one product specific plan that is available to the transaction, along with corresponding funding sources (e.g., at least one of a credit account, a prepaid account, a loan account, and/or the like) associated with that plan. For example, one or more products may be funded by one or more different funding sources.

As shown in FIG. 13, at step 1324, transaction processing system 1301 may indicate to issuer system 1306 that the transaction is qualified for dynamic processing, as described herein. For example, the transaction processing system 1301 may communicate a modified authorization request associated with the available product plan(s) and/or the corresponding funding sources.

As shown in FIG. 13, at step 1325, issuer system 1306 may confirm the dynamic transaction (e.g., confirm the transaction is eligible for dynamic processing, as described herein). If so, issuer system 1306 may select a product plan and the associated funding source for the product plan (e.g., based on customized rules for the user), as described herein. Issuer system 1306 may communicate an authorization response to the transaction processing system 1301, as described herein. For example, the authorization response may include and/or indicate the selected product plan along and/or the funding source for the selected product plan. As such, the transaction has dynamically switched from a debit transaction to a funding account transaction.

In some non-limiting embodiments or aspects, issuer system 1306 may communicate the selection of the funding source to the user (e.g., a device of the user). As such, the user may be notified that the transaction that was initiated using the lead credential is now being processed using the selected funding source (and, if applicable, the product plan, such as the term and/or interest rate of an installment plan).

As shown in FIG. 13, at step 1326, transaction processing system 1301 may determine (e.g., check) that the information provided by issuer system 1306 includes data required for dynamic processing. If so, transaction processing system 1301 may process the transaction based on the selected funding source.

As shown in FIG. 13, at step 1327, transaction processing system 1301 may transmit a modified authorization response to acquirer system 1308, as described herein. For example, if the funding source has changed based on dynamic processing, the modified authorization response may include any additional information that would be required for clearing and/or settlement.

As shown in FIG. 13, at step 1328, if the transaction does not qualify for dynamic processing, the transaction may be processed as regular transaction (e.g., using a default account, such as the debit or credit account presented to initiate the transaction or a default debit or credit account associated with the lead credential), as described herein.

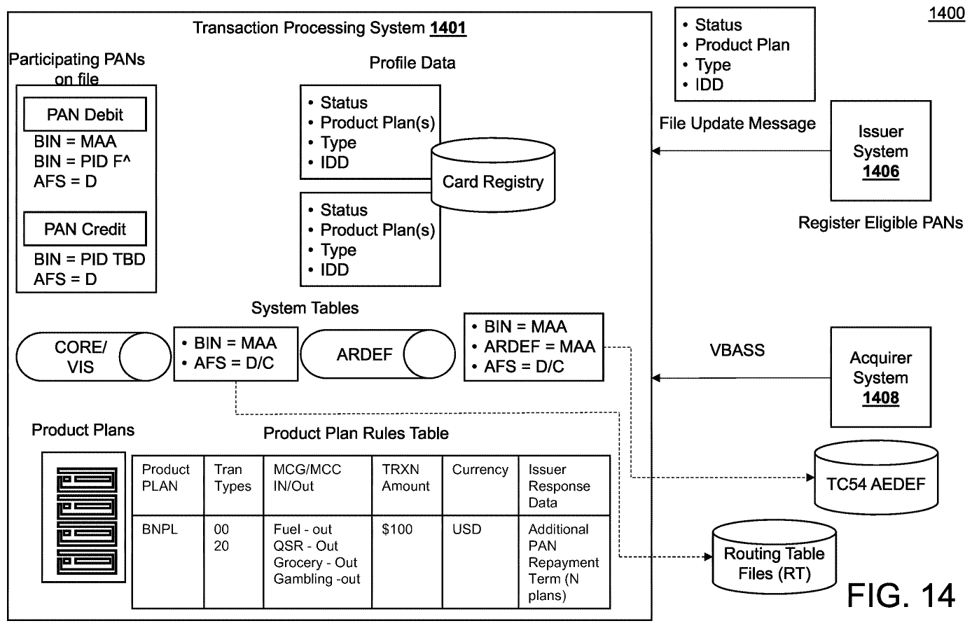

Referring now to FIG. 14, shown is a schematic diagram of an example implementation 1400 of a system for multi account access based on a single credential, according to some non-limiting embodiments or aspects. As shown in FIG. 14, implementation 1400 may include acquirer system 1408, transaction processing system 1401, and issuer system 1406. In some non-limiting embodiments or aspects, acquirer system 1408 may be the same as or similar to acquirer system 108. In some non-limiting embodiments or aspects, transaction processing system 1401 may be the same as or similar to transaction processing system 101. In some non-limiting embodiments or aspects, issuer system 1406 may be the same as or similar to issuer system 106. The number and arrangement of systems and/or devices shown in FIG. 14 are provided as an example. There may be additional systems and/or devices, fewer systems and/or devices, different systems and/or devices, and/or differently arranged systems and/or devices than those shown in FIG. 14.

As shown in FIG. 14, profile data may include data (e.g., stored in a database, such as a card registry) associated with account identifiers and/or account information that is eligible for the multi account access model. For example, profile data may include the status, product plan(s), account type (e.g., debit, credit, loan, BNPL, etc.), issuer discretionary data (IDD), any combination thereof, and/or the like. Participating PANS on file may include account identifiers as well as other related information, such as BIN, PID, AFS, multiple account access (MAA) indicator (e.g., an indicator that the PAN is eligible for dynamic processing), and/or the like.

The system tables may include configuration data for storing product plan details and/or routing tables for processing the transactions per the product plans. For example, the ARDEF may be as described herein. The product plans may be as described herein. The product plan rules table may be associated with and/or based on the customized rules, as described herein. For example, the rules table may include rules associated with each product plan to be used for identifying whether a transaction can be processed according to the one or more product plans.

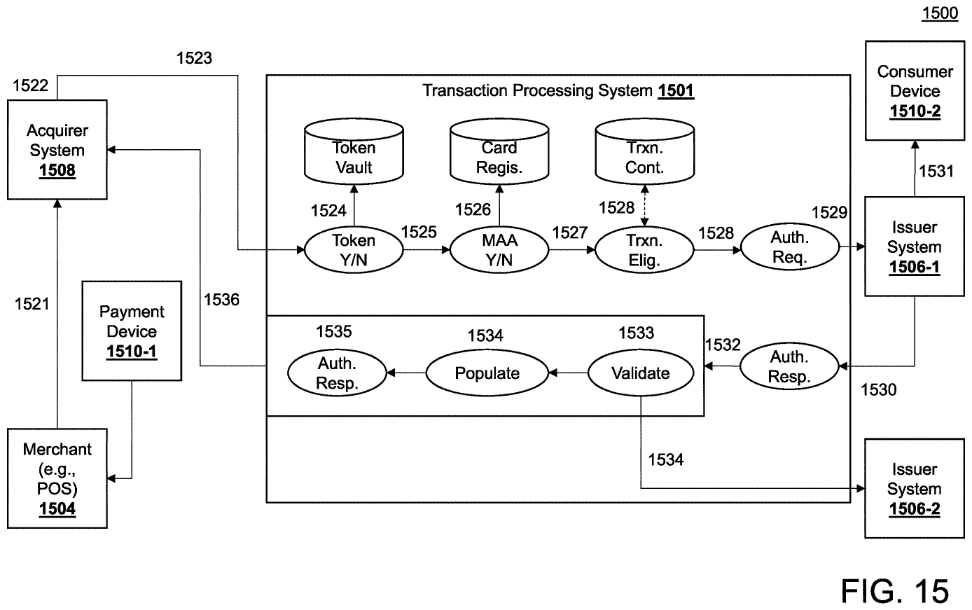

Referring now to FIG. 15, shown is a schematic diagram of an example implementation 1500 of a transaction flow in a system for multi account access based on a single credential, according to some non-limiting embodiments or aspects. The steps shown in FIG. 15 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown in FIG. 15, implementation 1500 may include payment device 1510-1, consumer device 1510-2, merchant system 1504, acquirer system 1508, transaction processing system 1501, first issuer system 1506-1, and second issuer system 1506-2. In some non-limiting embodiments or aspects, payment device 1510-1 and/or consumer device 1510-2 may be the same as or similar to consumer device 110. In some non-limiting embodiments or aspects, payment device 1510-1 and consumer device 1510-2 may be associated with the same user and/or be the same device. In some non-limiting embodiments or aspects, payment device 1510-1 may be separate from consumer device 1510-2. In some non-limiting embodiments or aspects, merchant system 1504 may be the same as or similar to merchant system 104. In some non-limiting embodiments or aspects, acquirer system 1508 may be the same as or similar to acquirer system 108. In some non-limiting embodiments or aspects, transaction processing system 1501 may be the same as or similar to transaction processing system 101. In some non-limiting embodiments or aspects, first issuer system 1506-1 and/or second issuer system 1506-2 may be the same as or similar to issuer system 106. The number and arrangement of systems and/or devices shown in FIG. 15 are provided as an example. There may be additional systems and/or devices, fewer systems and/or devices, different systems and/or devices, and/or differently arranged systems and/or devices than those shown in FIG. 15.

As shown in FIG. 15, at step 1521, after a user presents payment device 1510-1 to merchant system 1504 (e.g., a POS device/terminal thereof), merchant system 1504 may transmit an authorization request message to acquirer 1508, as described herein. For example, the account identifier associated with payment device 1510-1 may be a payment token, as described herein.

As shown in FIG. 15, at step 1522, acquirer system 1508 may determine to route the authorization request message to transaction processing system 1501 (e.g., based on the payment token), as described herein.

As shown in FIG. 15, at step 1523, acquirer system 1508 may transmit the authorization request message to transaction processing system 1501, as described herein.

As shown in FIG. 15, at step 1524, transaction processing system 1501 may determine that the authorization request message includes a payment token. If so, transaction processing system 1524 and/or a token vault thereof may detokenize the payment token, as described herein. For example, the PAN (e.g., lead PAN) corresponding to the payment token may be retrieved (e.g., by transaction processing system 1501) from the token vault.

As shown in FIG. 15, at step 1525, transaction processing system 1501 may determine whether the detokenized account identifier (e.g., PAN) and/or the transaction is eligible for dynamic processing (e.g., MAA), as described herein. For example, as shown in FIG. 15, at step 1526, transaction processing system 1501 may retrieve the profile data including the product plans and the associated rules from a card registry of transaction processing system 1501, as described herein.

As shown in FIG. 15, at step 1527, the transaction processing system may determine whether the transaction satisfies the eligibility requirements, as described herein. For example, as shown in FIG. 15, at step 1528, transaction processing system 1501 may communicate with a transaction controls database (e.g., which may store data associated with the customized rules and/or the like, as described herein).

As shown in FIG. 15, at step 1528, transaction processing system 1501 may generate a modified authorization request, as descried herein. As shown in FIG. 15, at step 1529, transaction processing system 1801 may transmit the modified authorization request (e.g., including and/or based on the eligible product plans) to first issuer system 1506-1. First issuer system 1506-1 may perform the eligibility checks, as described herein.

As shown in FIG. 15, at step 1530, if first issuer system 1506-1 agrees that the transaction qualifies for one or more of the product plans, first issuer system 1506-1 may make a selection (e.g., select one of the product plans) and/or communicate an authorization response message to transaction processing system. As shown in FIG. 15, at step 1531, first issuer system 1506-1 may communicate a notification to consumer device 1510-2, as described herein.

As shown in FIG. 15, at step 1532, transaction processing system may receive the authorization response, as described herein. For example, the authorization response message may include the lead PAN, the selected product plan, and/or the required data (e.g., funding source identifier, funding PAN, and/or the like), as described herein.

As shown in FIG. 15, at step 1533, transaction processing system 1501 validates the information received from issuer system, as described herein. For example, transaction processing system 1501 may process the transaction using the funding PAN according to the rules of the selected product plan. In some non-limiting embodiments or aspects, as shown in FIG. 15, at step 1534, if the funding PAN is issued by second issuer system 1506-2 (e.g., or is associated with a product plan that is managed by a secondary system of a same issuer), transaction processing system 1501 may transmit a communication to second issuer system 1506-2. For example, the communication may inform second issuer system 1506-2 that the transaction has been authorized and is being processed using the funding PAN.

As shown in FIG. 15, at step 1534, transaction processing system 1501 may populate at least one additional field of an authorization response, as described herein. Additionally or alternatively, as shown in FIG. 15, at step 1535, transaction processing system 1501 may generate a modified authorization response (e.g., based on populating the additional field(s) of the authorization response), as described herein.

As shown in FIG. 15, at step 1536, transaction processing system 1501 may transmit the modified authorization response message to acquirer system 1508, as described herein. For example, the modified authorization response message may include the information necessary for the acquirer to clear and/or settle the transaction at a later time.

In some non-limiting embodiments or aspects, at step 1528, transaction processing system 1501 may be able to retrieve the funding PAN directly (e.g., from transaction controls database) rather than receiving the funding PAN from the issuer system(s). For example, the funding PAN for one or more product plans may be stored at a database (e.g., transaction controls database). Transaction processing system 1501 may access the database to identify the funding PAN for a product plan that is selected among the available product plans by transaction processing system 1501 or by the issuer system(s). For example, the issuer system(s) may return a selection of the product plan without providing the funding PAN associate with the selected product to transaction processing system 1501, and transaction processing system 1501 may then retrieve the funding PAN from the database by querying the database for the product plan selected by the issuer system(s).

In some non-limiting embodiments or aspects, if first issuer system 1506-1 does not have enough information, the first issuer system 1506-1 may communicate (e.g., return) the funding PAN to transaction processing system 1501 at steps 1530 and/or 1532, without providing an authorization response. As such, transaction processing system 1501 may then reach out to the second issuer system 15606-2 with a (modified) authorization request using the funding PAN.

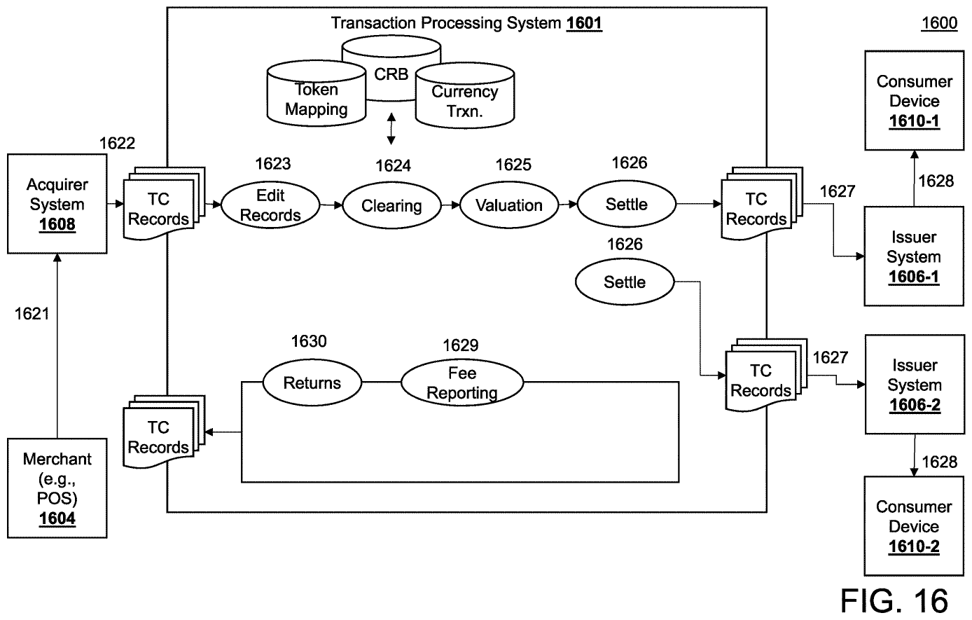

Referring now to FIG. 16, shown is a schematic diagram of an example implementation 1600 of a clearing/settlement flow in a system for multi account access based on a single credential, according to some non-limiting embodiments or aspects. The steps shown in FIG. 16 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown in FIG. 16, implementation 1600 may include first consumer device 1610-1, second consumer device 1610-2, merchant system 1604, acquirer system 1608, transaction processing system 1601, first issuer system 1606-1, and second issuer system 1606-2. In some non-limiting embodiments or aspects, first consumer device 1610-1 and/or second consumer device 1610-2 may be the same as or similar to consumer device 110. In some non-limiting embodiments or aspects, consumer device 1610-1 and second consumer device 1610-2 may be associated with the same user and/or be the same device. In some non-limiting embodiments or aspects, first consumer device 1610-1 may be separate from second consumer device 1610-2. In some non-limiting embodiments or aspects, merchant system 1604 may be the same as or similar to merchant system 104. In some non-limiting embodiments or aspects, acquirer system 1608 may be the same as or similar to acquirer system 108. In some non-limiting embodiments or aspects, transaction processing system 1601 may be the same as or similar to transaction processing system 101. In some non-limiting embodiments or aspects, first issuer system 1606-1 and/or second issuer system 1606-2 may be the same as or similar to issuer system 106. The number and arrangement of systems and/or devices shown in FIG. 16 are provided as an example. There may be additional systems and/or devices, fewer systems and/or devices, different systems and/or devices, and/or differently arranged systems and/or devices than those shown in FIG. 16.

As shown in FIG. 16, at step 1621, merchant system 1604 may communicate at least one clearing message (e.g., capture message) to acquirer system 1608, as described herein.

As shown in FIG. 16, at step 1622, acquirer system 1608 may communicate at least one clearing message (e.g., including at least one transaction clearing (TC) record) to transaction processing system 1601, as described herein. For example, the clearing message(s) (e.g., TC record(s)) from acquirer system 1608 may include and/or by based on the lead credentials that were presented by the user to merchant system 1604 to initiate the transaction(s). In some non-limiting embodiments or aspects, the clearing message(s) (e.g., TC record(s)) may be based on the ARDEF, the MAA indicator, and/or clearing logic. Additionally or alternatively, the clearing message(s) (e.g., TC record(s)) may be based on IRF request logic.

As shown in FIG. 16, at step 1623, transaction processing system 1601 may edit (e.g., modify) the clearing message(s) (e.g., TC record(s)) based on dynamic processing of the transactions, as described herein. For example, transaction processing system 1601 may modify and/or populate fields of the clearing message(s) (e.g., TC record(s)) based on the MAA indicator and the secondary funding source used for each dynamic transaction (e.g., MAA transaction).

As shown in FIG. 16, at step 1624, transaction processing system 1601 may perform clearing of the transaction(s). For example, transaction processing system 1601 may utilize at least one of a token mapping database (e.g., token vault), a currency transaction database, a card recovery bulletin (CRB) database, any combination thereof, and/or the like to clear the transaction(s) (e.g., to look up the PAN associated with each token, to convert between currencies, and to check CRB data, respectively).

As shown in FIG. 16, at step 1625, transaction processing system 1601 may perform valuation of the transaction(s). For example, transaction processing system 1601 may calculate the IRF for each transaction. For each dynamic transaction (e.g., MAA transaction), transaction processing system 1601 may calculate the IRF based on the secondary funding source, as described herein.

As shown in FIG. 16, at step 1626, transaction processing system 1601 may generate at least one settlement message (e.g., based on the TC records) for at least one of first issuer system 1606-1 and/or second issuer system 1606-2. For example, if a transaction was not a dynamic transaction (e.g., not eligible for dynamic processing), the settlement message for that transaction may be generated for first issuer system 1606-1 (e.g., associated with the credential presented to initiate the transaction). Additionally or alternatively, if a transaction was a dynamic transaction (e.g., eligible for dynamic processing), the settlement message for that transaction may be generated for second issuer system 1606-2 (e.g., associated with the identifier of the secondary funding source selected for transaction).

As shown in FIG. 16, at step 1627, transaction processing system 1601 may communicate at least one settlement message for at least one of first issuer system 1606-1 and/or second issuer system 1606-2. For example, if a transaction was not a dynamic transaction (e.g., not eligible for dynamic processing), the settlement message for that transaction may be communicated to first issuer system 1606-1 (e.g., associated with the credential presented to initiate the transaction). Additionally or alternatively, if a transaction was a dynamic transaction (e.g., eligible for dynamic processing), the settlement message for that transaction may be communicated to second issuer system 1606-2 (e.g., associated with the identifier of the secondary funding source selected for transaction).

As shown in FIG. 16, at step 1628, first issuer system 1506-1 may communicate a notification to first consumer device 1510-1, and/or second issuer system 1506-1 may communicate a notification to second consumer device 1510-2, as described herein.

As shown in FIG. 16, at step 1629, transaction processing system 1601 may perform and/or determine fee reporting (e.g., based on valuation and/or IRF fees), as described herein.

As shown in FIG. 16, at step 1630, transaction processing system 1601 may process returns (e.g., transactions indicating products were returned to a merchant and/or the like).

In some non-limiting embodiments or aspects, the disclosed subject matter enables accessing multiple funding sources (e.g., funding accounts) using a single credential (e.g., using a loan account to fund an installment transaction). Additionally or alternatively, the user may initiate a transaction with a first funding source associated with a credential and then switch to a second funding source associated with the same credential (or a different credential) to process the transaction. The issuer and/or cardholder may access the desired account permitted by the issuer using a single credential. The funding source may include one or more of a debit account, a credit account, a line of credit account, loyalty points, a consumer loan account, a BNPL account, a commercial loan account, and/or the like.

In some non-limiting embodiments or aspects, the disclosed subject matter allows for initiating a transaction at a merchant using a credential. The credential may be associated with a first account (e.g., a debit account). However, the user may have predetermined (e.g., customized) rules associated with the credential. The predetermined (e.g., customized) rules may indicate a request to process a transaction above a threshold amount or with a particular merchant using a loan account. As such, after initiating the transaction with the first account, the transaction processing system (e.g., of a transaction service provider entity) may confirm that the transaction matches (e.g., triggers) the predetermined rules, and may switch the source account to the second account (e.g., a loan account). Accordingly, a consumer debit transaction may be switched to a commercial credit transaction.

In some non-limiting embodiments or aspects, the transaction processing system may receive a transaction authorization request including at least a credential, a transaction amount and a merchant identifier. The transaction processing network may analyze the transaction authorization request, and identify one or more predetermined rules to be applied to the transaction. For example, a portion of the predetermined rules may be set by the account holder, and/or a portion of the predetermined rules may be set by the transaction processing network. The credential may be associated with multiple funding sources of different types (e.g., debit type funding sources, credit type funding sources, loan type funding sources). For example, upon analyzing the transaction authorization request, the transaction processing system may determine that the transaction should be processed as a BNPL transaction. The transaction processing system may communicate with an issuer of the loan account to determine whether the BNPL transaction will be funded by a commercial loan source or a consumer loan source.

In some non-limiting embodiments or aspects, the credential may not be associated with funding sources. The credential may identify the user (e.g., the account holder). The user may have one or more accounts registered with the transaction processing server. When the transaction processing server receives the transaction authorization request, the transaction processing server may identify the available funding sources based on transaction information, such as the transaction amount and/or the merchant identity. The transaction processing system may notify the issuer of the available funding sources, and the issuer may select the appropriate funding source for the transaction. Accordingly, a lead credential may be presented to initiate the transaction, and the transaction may be processed (e.g., funded) using a funding credential, funding source that is different than the lead credential.

In some non-limiting embodiments or aspects, the transaction processing system may identify and assign BIN and enable ALP, or create a Modern Credential indicator (e.g., a lead credential indicator, an MAA indicator, and/or the like); configure and confirm the issuer defined eligibility criteria and transaction controls, if needed, on the credential; and/or define the complete set of program identifiers (e.g., for the funding account(s)).

In some non-limiting embodiments or aspects, the issuer may define the eligibility criteria for a transaction; inform the transaction processing system about the credential (e.g., of a secondary funding source, such as product ID, program ID, and configuration information (e.g., from a credential registry), associated funding information for each program, and/or the like). In some non-limiting embodiments or aspects, the issuer or the user/account holder can set (e.g., customize) rules governing transaction processing logic. For example, the rule may include bundling PANs, ATM, POS, Ecom routing logic (default PAN), transaction amount, transaction channel, MCC, individual merchant-based rules (e.g., transaction>$100 or jewelry transaction routed to credit account), any combination thereof, and/or the like.

In some non-limiting embodiments or aspects, the acquirer system(s) may receive ARDEF files, prepare to send merchant identifiers (e.g., merchant ID, VMID, and/or the like), and/or be able to process with a different funding source.

In some non-limiting embodiments or aspects, the merchant may be given the option to opt in or out, or may pass the choice to the customer.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

1. A system, comprising:
at least one processor configured to:
receive, from an acquirer system, an authorization request message associated with a transaction, the authorization request message comprising a first account identifier;
determine that at least one of the transaction, the first account identifier, or any combination thereof qualifies for dynamic processing;
identify at least one processing option available for the dynamic processing of the transaction;
transmit a modified authorization request message to an issuer system, the modified authorization request message indicating the at least one processing option;
receive an authorization response message from the issuer system, the authorization response message comprising an authorization indicator and an identifier for a funding source compatible with a selected processing option of the at least one processing option; and
transmit a modified authorization response message based on the authorization indicator and the identifier for the funding source to the acquirer system.

2. The system of claim 1, wherein the first account identifier comprises a lead credential.

3. The system of claim 1, wherein the lead credential identifies at least one of an accountholder, a default payment account, or any combination thereof.

4. The system of claim 1, wherein dynamic processing comprises deferred processing.

5. The system of claim 1, wherein the identifier for the funding source comprises a second account identifier.

6. The system of claim 1, wherein the identifier for the funding source comprises at least one of a product identifier (PID), an account funding source (AFS), or any combination thereof.

7. The system of claim 1, wherein the at least one processing option comprises at least two processing options associated with a same funding source.

8. The system of claim 1, wherein the at least one processing option comprises at least two processing options each associated with a different funding source.

9. The system of claim 1, wherein the at least one processor is further configured to, before transmitting the modified authorization response message:
process the transaction based on the identifier for the funding source and the selected processing option; and
generate the modified authorization response message based on processing the transaction.

10. The system of claim 1, wherein the issuer system is configured to:
determine the selected processing option based on customized rules associated with an account holder associated with the first account identifier;
determine the funding source compatible with the selected processing option; and
generate the authorization response message comprising the authorization indicator and the identifier for the funding source compatible with the selected processing option.

11. The system of claim 1, wherein the issuer system is configured to receive at least one input associated with the customized rules from the account holder.

12. A computer-implemented method, comprising:
receiving, with at least one processor from an acquirer system, an authorization request message associated with a transaction, the authorization request message comprising a first account identifier;
determining, with at least one processor, that at least one of the transaction, the first account identifier, or any combination thereof qualifies for dynamic processing;
identifying, with at least one processor, at least one processing option available for the dynamic processing of the transaction;
transmitting, with at least one processor, a modified authorization request message to an issuer system, the modified authorization request message indicating the at least one processing option;
receiving, with at least one processor, an authorization response message from the issuer system, the authorization response message comprising an authorization indicator and an identifier for a funding source compatible with a selected processing option of the at least one processing option; and
transmitting, with at least one processor, a modified authorization response message based on the authorization indicator and the identifier for the funding source to the acquirer system.

13. The method of claim 12, wherein the first account identifier comprises a lead credential, and wherein the lead credential identifies at least one of an accountholder, a default payment account, or any combination thereof.

14. The method of claim 12, wherein dynamic processing comprises deferred processing.

15. The method of claim 12, wherein the identifier for the funding source comprises a second account identifier.

16. The method of claim 12, wherein the identifier for the funding source comprises at least one of a product identifier (PID), an account funding source (AFS), or any combination thereof.

17. The method of claim 12, wherein the at least one processing option comprises at least one of the following:
at least two processing options associated with a same funding source,
at least two processing options each associated with a different funding source, or
any combination thereof.

18. The method of claim 12, further comprising, before transmitting the modified authorization response message:
processing, with at least one processor, the transaction based on the identifier for the funding source and the selected processing option before transmitting the modified authorization response message; and
generating, with at least one processor, the modified authorization response message based on processing the transaction.

19. The method of claim 12, further comprising:
receiving, by the issuer system, at least one input associated with customized rules from an account holder associated with the first account identifier;
determining, by the issuer system, the selected processing option based on the customized rules associated with the account holder;
determining, by the issuer system, the funding source compatible with the selected processing option; and
generating, by the issuer system, the authorization response message comprising the authorization indicator and the identifier for the funding source compatible with the selected processing option.

20. A computer program product comprising at least one non-transitory computer-readable medium including program instructions that, when executed by at least one processor, cause the at least one processor to:
receive, from an acquirer system, an authorization request message associated with a transaction, the authorization request message comprising a first account identifier;
determine that at least one of the transaction, the first account identifier, or any combination thereof qualifies for dynamic processing;
identify at least one processing option available for the dynamic processing of the transaction;
transmit a modified authorization request message to an issuer system, the modified authorization request message indicating the at least one processing option;
receive an authorization response message from the issuer system, the authorization response message comprising an authorization indicator and an identifier for a funding source compatible with a selected processing option of the at least one processing option; and
transmit a modified authorization response message based on the authorization indicator and the identifier for the funding source to the acquirer system.

21. A computer program product comprising at least one non-transitory computer-readable medium including program instructions that, when executed by at least one processor, cause the at least one processor to perform the method of claim 12.
